(19) United States
(12) Patent Application Publication
(10) Pub. No.: US 2026/0223129 A1
(43) Pub. Date: Jul. 30, 2026

(54) REFLECTION MODULATION VIA SUBCARRIER INDICES

(71) Applicant: QUALCOMM Incorporated, San Diego, CA (US)

(72) Inventors: Yavuz YAPICI, Florham Park, NJ (US); Juergen CEZANNE, Ocean Township, NJ (US); Junyi LI, Greentown, PA (US)

(21) Appl. No.: 19/036,497

(22) Filed: Jan. 24, 2025

(51) Int. Cl. H04W 72/232; H04L 5/00

(52) U.S. Cl. CPC H04W 72/232; H04L 5/0046; H04L 5/0053

(57) ABSTRACT

Methods, systems, and devices for wireless communications are described. A wireless device may obtain an incident signal. In some implementations, the wireless device may select a chip rate according to a subcarrier data mapping, and the wireless device may generate a reflected signal in accordance with a periodic load switching pattern applied to the incident signal at a frequency corresponding to the selected chip rate. Accordingly, the wireless device may output the reflected signal, where a first subset of resource elements of the reflected signal are energy-bearing resource elements that satisfy the subcarrier data mapping, and a second subset of resource elements of the reflected signal are non-energy-bearing resource elements that satisfy the subcarrier data mapping.

### FIELD OF TECHNOLOGY

The following relates to wireless communications, including reflection modulation via subcarrier indices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a first wireless device is described. The method may include obtaining an incident signal, selecting a chip rate according to a subcarrier data mapping, generating a reflected signal in accordance with a periodic load switching pattern applied to the incident signal at a frequency corresponding to the selected chip rate, and outputting the reflected signal, where a first subset of resource elements (REs) of the reflected signal are energy-bearing REs that satisfy the subcarrier data mapping, and a second subset of REs of the reflected signal are non-energy-bearing REs that satisfy the subcarrier data mapping.

A first wireless device for wireless communications is described. The first wireless device may include one or more memories storing processor executable code, and one or more processors coupled with the one or more memories. The one or more processors may individually or collectively be operable to execute the code to cause the first wireless device to obtain an incident signal, select a chip rate according to a subcarrier data mapping, generate a reflected signal in accordance with a periodic load switching pattern applied to the incident signal at a frequency corresponding to the selected chip rate, and output the reflected signal, where a first subset of REs of the reflected signal are energy-bearing REs that satisfy the subcarrier data mapping, and a second subset of REs of the reflected signal are non-energy-bearing REs that satisfy the subcarrier data mapping.

Another first wireless device for wireless communications is described. The first wireless device may include means for obtaining an incident signal, means for selecting a chip rate according to a subcarrier data mapping, means for generating a reflected signal in accordance with a periodic load switching pattern applied to the incident signal at a frequency corresponding to the selected chip rate, and means for outputting the reflected signal, where a first subset of REs of the reflected signal are energy-bearing REs that satisfy the subcarrier data mapping, and a second subset of REs of the reflected signal are non-energy-bearing REs that satisfy the subcarrier data mapping.

A non-transitory computer-readable medium storing code for wireless communications is described. The code may include instructions executable by one or more processors to obtain an incident signal, select a chip rate according to a subcarrier data mapping, generate a reflected signal in accordance with a periodic load switching pattern applied to the incident signal at a frequency corresponding to the selected chip rate, and output the reflected signal, where a first subset of REs of the reflected signal are energy-bearing REs that satisfy the subcarrier data mapping, and a second subset of REs of the reflected signal are non-energy-bearing REs that satisfy the subcarrier data mapping.

In some examples of the method, first wireless devices, and non-transitory computer-readable medium described herein, the incident signal may be obtained via one or more initial energy-bearing REs and the method, apparatuses, and non-transitory computer-readable medium may include further operations, features, means, or instructions for performing, by applying the periodic load switching pattern, a frequency domain shift to the one or more initial energy-bearing REs according to the subcarrier data mapping, where one or more shifted energy-bearing REs include the first subset of REs.

In some examples of the method, first wireless devices, and non-transitory computer-readable medium described herein, a threshold chip rate corresponds to a threshold shifting offset and performing the frequency domain shift may be in accordance with the threshold shifting offset.

Some examples of the method, first wireless devices, and non-transitory computer-readable medium described herein may further include operations, features, means, or instructions for communicating a set of data associated with the first wireless device in accordance with applying the periodic load switching pattern, where the set of data may be indicated by a frequency domain location of the first subset of REs.

Some examples of the method, first wireless devices, and non-transitory computer-readable medium described herein may further include operations, features, means, or instructions for determining a first modulation window, where selecting the chip rate may be in accordance with the first modulation window.

In some examples of the method, first wireless devices, and non-transitory computer-readable medium described herein, the energy-bearing REs, the non-energy-bearing REs, or both may be included within at least the first modulation window.

In some examples of the method, first wireless devices, and non-transitory computer-readable medium described herein, a width of the first modulation window may be in accordance with a bandwidth, a subcarrier spacing, or both corresponding to a communication channel of the first wireless device and the width of the first modulation window may be further in accordance with the subcarrier data mapping.

Some examples of the method, first wireless devices, and non-transitory computer-readable medium described herein may further include operations, features, means, or instructions for determining one or more second modulation windows, where a quantity of modulation windows including a first modulation window and the one or more second modulation windows corresponds to a quantity of data bits associated with the first wireless device, a bandwidth, a subcarrier spacing, or any combination thereof corresponding to a communication channel of the first wireless device.

Some examples of the method, first wireless devices, and non-transitory computer-readable medium described herein may further include operations, features, means, or instructions for obtaining, within the one or more second modulation windows, one or more repetitions of the incident signal, where the one or more repetitions of the incident signal include one or more REs that may be different than one or more REs of the incident signal and outputting one or more additional reflected signals within the one or more second modulation windows in accordance with receiving the one or more repetitions of the incident signal and applying the periodic load switching pattern to the one or more repetitions of the incident signal.

In some examples of the method, first wireless devices, and non-transitory computer-readable medium described herein, each repetition of the one or more repetitions of the incident signal corresponds to a different modulation window of the one or more second modulation windows.

In some examples of the method, first wireless devices, and non-transitory computer-readable medium described herein, a first portion of the energy-bearing REs, the non-energy-bearing REs, or both may be included within a first modulation window and a second portion of the energy-bearing REs, the non-energy-bearing REs, or both may be included within the one or more second modulation windows.

Some examples of the method, first wireless devices, and non-transitory computer-readable medium described herein may further include operations, features, means, or instructions for receiving an indication of a threshold shifting offset in accordance with a power leakage value, where selecting the chip rate may be in accordance with the threshold shifting offset.

Some examples of the method, first wireless devices, and non-transitory computer-readable medium described herein may further include operations, features, means, or instructions for generating a set of data, where selecting the chip rate may be in accordance with the set of data.

A method for wireless communications by a second wireless device is described. The method may include outputting, via a first wireless device to a third wireless device, an incident signal including one or more initial energy-bearing REs and outputting, to at least one of the first wireless device or the third wireless device, an indication of a subcarrier data mapping, the subcarrier data mapping corresponding to a set of data associated with the first wireless device.

A second wireless device for wireless communications is described. The second wireless device may include one or more memories storing processor executable code, and one or more processors coupled with the one or more memories. The one or more processors may individually or collectively be operable to execute the code to cause the second wireless device to output, via a first wireless device to a third wireless device, an incident signal including one or more initial energy-bearing REs and output, to at least one of the first wireless device or the third wireless device, an indication of a subcarrier data mapping, the subcarrier data mapping corresponding to a set of data associated with the first wireless device.

Another second wireless device for wireless communications is described. The second wireless device may include means for outputting, via a first wireless device to a third wireless device, an incident signal including one or more initial energy-bearing REs and means for outputting, to at least one of the first wireless device or the third wireless device, an indication of a subcarrier data mapping, the subcarrier data mapping corresponding to a set of data associated with the first wireless device.

A non-transitory computer-readable medium storing code for wireless communications is described. The code may include instructions executable by one or more processors to output, via a first wireless device to a third wireless device, an incident signal including one or more initial energy-bearing REs and output, to at least one of the first wireless device or the third wireless device, an indication of a subcarrier data mapping, the subcarrier data mapping corresponding to a set of data associated with the first wireless device.

In some examples of the method, second wireless devices, and non-transitory computer-readable medium described herein, the incident signal may be output during a first modulation window and the method, apparatuses, and non-transitory computer-readable medium may include further operations, features, means, or instructions for outputting, within one or more second modulation windows that may be non-overlapping with the first modulation window, one or more repetitions of the incident signal.

In some examples of the method, second wireless devices, and non-transitory computer-readable medium described herein, a quantity of the one or more second modulation windows may be determined in accordance with a threshold demodulation accuracy.

Some examples of the method, second wireless devices, and non-transitory computer-readable medium described herein may further include operations, features, means, or instructions for outputting an indication of a threshold shifting offset in accordance with a power leakage value.

Some examples of the method, second wireless devices, and non-transitory computer-readable medium described herein may further include operations, features, means, or instructions for outputting an indication that the subcarrier data mapping includes an initial energy-bearing RE associated with the incident signal, one or more shifted energy-bearing REs including one or more frequency domain shifts of the initial energy-bearing RE, or any combination thereof in accordance with the threshold shifting offset.

In some examples of the method, second wireless devices, and non-transitory computer-readable medium described herein, the incident signal may be output during a first modulation window and the method, apparatuses, and non-transitory computer-readable medium may include further operations, features, means, or instructions for communicating, within one or more second modulation windows that may be non-overlapping with the first modulation window, additional signaling with one or more additional devices.

In some examples of the method, second wireless devices, and non-transitory computer-readable medium described herein, the one or more additional devices include user equipments (UEs).

Some examples of the method, second wireless devices, and non-transitory computer-readable medium described herein may further include operations, features, means, or instructions for outputting an indication of a quantity of bits associated with the first wireless device.

In some examples of the method, second wireless devices, and non-transitory computer-readable medium described herein, the indication of the quantity of bits includes a synchronization message.

In some examples of the method, second wireless devices, and non-transitory computer-readable medium described herein, a quantity of modulation windows associated with communication at the first wireless device corresponds to a quantity of data bits associated with the first wireless device, a bandwidth, a subcarrier spacing, or any combination thereof.

Some examples of the method, second wireless devices, and non-transitory computer-readable medium described herein may further include operations, features, means, or instructions for selecting a modulation scheme corresponding to at least the incident signal and outputting an indication of the modulation scheme in accordance with selecting the modulation scheme and in accordance with applying the modulation scheme for at least the incident signal.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports reflection modulation via subcarrier indices in accordance with one or more aspects of the present disclosure.

FIG. 2 shows an example of a wireless communications system that supports reflection modulation via subcarrier indices in accordance with one or more aspects of the present disclosure.

FIG. 3 shows an example of a block diagram that supports reflection modulation via subcarrier indices in accordance with one or more aspects of the present disclosure.

FIG. 4 shows an example of a signaling diagram that supports reflection modulation via subcarrier indices in accordance with one or more aspects of the present disclosure.

FIG. 5 shows an example of a process flow that supports reflection modulation via subcarrier indices in accordance with one or more aspects of the present disclosure.

FIGS. 6 and 7 show block diagrams of devices that support reflection modulation via subcarrier indices in accordance with one or more aspects of the present disclosure.

FIG. 8 shows a block diagram of a communications manager that supports reflection modulation via subcarrier indices in accordance with one or more aspects of the present disclosure.

FIG. 9 shows a diagram of a system including a device that supports reflection modulation via subcarrier indices in accordance with one or more aspects of the present disclosure.

FIGS. 10 through 14 show flowcharts illustrating methods that support reflection modulation via subcarrier indices in accordance with one or more aspects of the present disclosure.

### DETAILED DESCRIPTION

In some wireless communication systems, a wireless communication device (e.g., a low-power device) such as an ambient Internet of Things (A-IoT) device, or a reconfigurable intelligent surfaces (RIS) device, among other examples, may communicate with a transmitter and a receiving device (e.g., a reader device) via reflection modulation (RM). In some cases, the low-power device may receive an incident signal from the transmitter and may perform RM by applying a periodic antenna load switching pattern to the received incident signal at a frequency associated with a chip rate (e.g., a pulse frequency, or pulse rate, among other examples) and according to one or more data bits associated with the low-power device. Applying the periodic antenna load switching pattern may introduce a time shift (e.g., time domain modulation) to the incident signal, forming a reflected RM signal (e.g., a time-shifted representation of the incident signal). Accordingly, the low-power device may output the reflected signal, and the reader device may receive the reflected signal and demodulate the reflected signal by comparing the reflected signal using an internal clock signal.

In some cases, the low-power device may perform RM by applying a periodic load switching pattern with a multilevel (e.g., complex) waveform (e.g., to mitigate extraneous signal harmonics, among other examples). However, in such cases, demodulating multilevel waveforms modulated with time domain RM may be ineffective and inefficient if demodulation is performed in the time domain (e.g., by the reader device). For example, the reader device may be unable to effectively perform time domain demodulation for multilevel waveforms based on the reader being unable to compare the multilevel waveform to an internal clock of the reader device, or the amplitude levels of the waveform may not be sufficiently distinct (e.g., to be detected accurately by the reader). Additionally, or alternatively, increasing a complexity of the modulation performed by the low-power device (e.g., performing a frequency domain modulation instead of time domain modulation) may increase the complexity of the low-power device, and may correspondingly increase power consumption.

Techniques described herein may enable the low-power device to perform modulation via subcarrier indices. Additionally, or alternatively, the reader device may perform frequency domain demodulation. In some implementations, the low-power device may select (e.g., vary) the chip rate to perform the periodic antenna load switching according to a subcarrier data mapping. By applying the periodic antenna load switching pattern according to the modified chip rate, the low-power device may shift one or more energy-bearing resource elements (REs) of the incident waveform to occupy one or more subcarriers (e.g., specific, or desired subcarriers, among other examples) of a reflected waveform. For example, the low-power device may obtain the incident signal via a set of REs including the energy-bearing REs corresponding to one or more initial subcarriers and the low-power device may apply the periodic load switching pattern such that the energy-bearing REs are shifted to occupy one or more different subcarriers. Accordingly, outputting the reflected signal may be via the shifted REs corresponding to the different subcarriers. In such examples, the occupancy of the subcarriers including the energy-bearing REs may indicate the data associated with the low-power device, and the reader device may correspondingly determine which subcarriers contain the energy-bearing REs (e.g., based on calculating or determining the frequency spectrum of the reflected signal).

By performing RM via subcarrier indices, the low-power device may utilize single-level waveforms, multilevel waveforms, or the like to generate reflected waveforms since the device does not have to discern the amplitude levels, which may support a relatively reduced device complexity. Accordingly, the low-power device may perform relatively low-complexity time domain modulation (e.g., compared to frequency domain modulation schemes) which may reduce power consumption.

Additionally, or alternatively, by performing RM via subcarrier indices, a reader device may experience a gain in demodulation accuracy in accordance with one or more repetitions of the incident signal and the reflected signal.

Aspects of the disclosure are initially described in the context of wireless communications systems. Aspects of the disclosure are further described in the context of wireless communications systems, block diagrams, signaling diagrams, and process flows. Aspects of the disclosure are further illustrated by and described with reference to apparatus diagrams, system diagrams, and flowcharts that relate to reflection modulation via subcarrier indices.

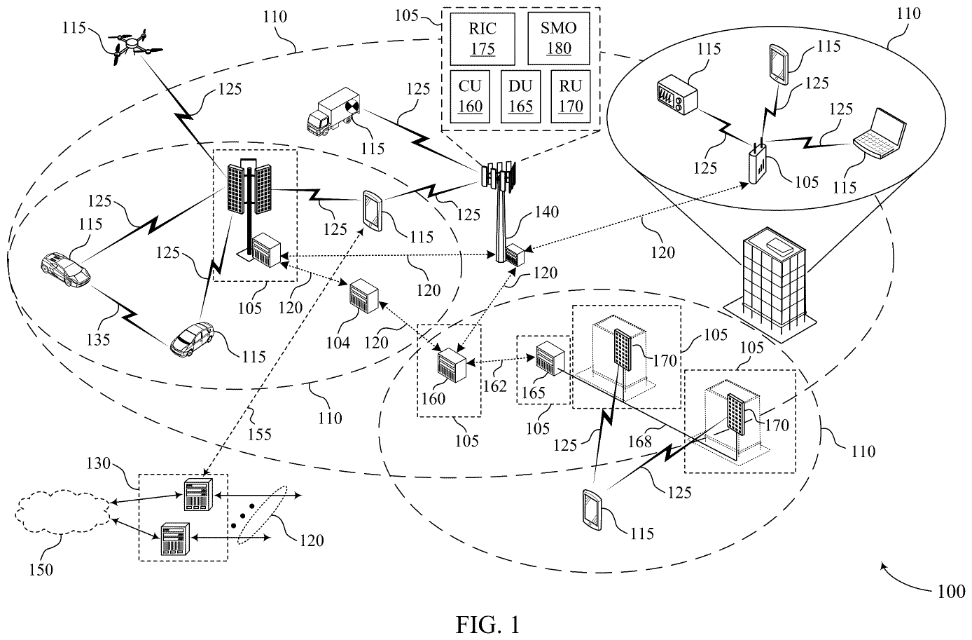

FIG. 1 shows an example of a wireless communications system 100 that supports reflection modulation via subcarrier indices in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support reflection modulation via subcarrier indices as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitter or a receiving device (e.g., a network entity 105, a UE 115) to shape or steer an antenna beam (e.g., a transmit beam, a receive beam) along a spatial path between the transmitter and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitter or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitter or receiving device, or with respect to some other orientation).

Techniques described herein may enable the low-power device to perform modulation via subcarrier indices. Additionally, or alternatively, the reader device may perform frequency domain demodulation. In some implementations, the low-power device may select (e.g., vary) the chip rate to perform the periodic antenna load switching according to a subcarrier data mapping. By applying the periodic antenna load switching pattern according to the modified chip rate, the low-power device may shift one or more energy-bearing resource elements (REs) of the incident waveform to occupy one or more subcarriers (e.g., specific, or desired subcarriers, among other examples) of a reflected waveform. For example, the low-power device may obtain the incident signal via a set of REs including the energy-bearing REs corresponding to one or more initial subcarriers and the low-power device may apply the periodic load switching pattern such that the energy-bearing REs are shifted to occupy one or more different subcarriers. Accordingly, outputting the reflected signal may be via the shifted REs corresponding to the different subcarriers. In such examples, the occupancy of the subcarriers including the energy-bearing REs may indicate the data associated with the low-power device, and the reader device may correspondingly determine which subcarriers contain the energy-bearing REs (e.g., based on calculating or determining the frequency spectrum of the reflected signal). The reflected signal may additionally include one or more non-energy-bearing REs. In some examples, the energy-bearing REs, the non-energy-bearing REs, or both may be included within one or more modulation windows, where a width (e.g., a frequency bandwidth) of a modulation window is based on a bandwidth of a communication band associated with the low-power device), a subcarrier spacing, a quantity of bits communicated by the low-power device, or any combination thereof.

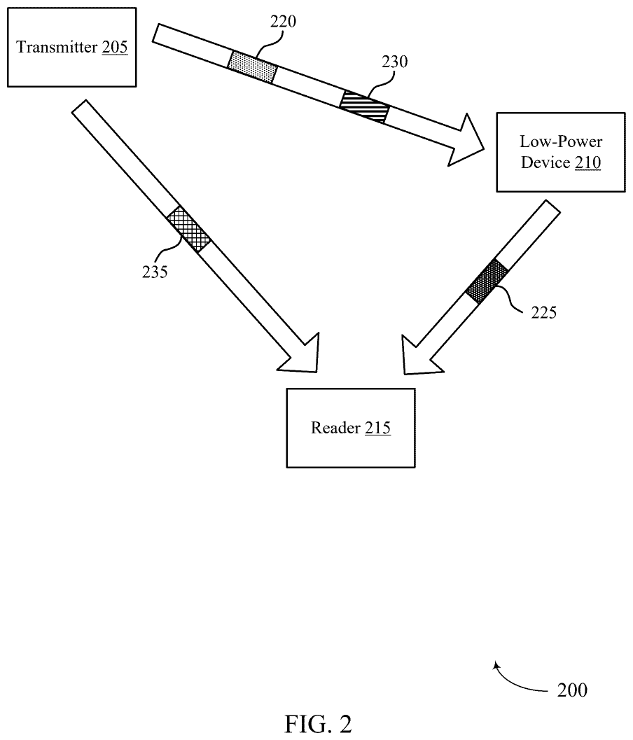

FIG. 2 shows an example of a wireless communications system 200 that supports reflection modulation via subcarrier indices in accordance with one or more aspects of the present disclosure. Aspects of the wireless communications system 200 may implement or be implemented by aspects of the wireless communications system 100. For example, the wireless communications system 200 may include a transmitter 205 and a reader 215, which may be examples of the network entity 105, the UEs 115, or the like. In some examples, the transmitter 205 and the reader 215 may be a same device, separate components included within a same entity (e.g., network node), or separate (e.g., discrete) devices, among other examples.

In some cases, a low-power device 210 (e.g., A-IoT devices, RISs, battery-less network nodes, or the like) may utilize RM to perform backscattering communications. In such cases, the low-power device 210 may perform RM by using periodic waveforms which govern switching patterns of one or more antenna loads and may induce a phase shift on a reflected (e.g., backscattered) wave by time-shifting the periodic pattern (e.g., incident waveform) according to a set of data to transmit (e.g., data associated with and stored at the low-power device 210). For example, the low-power device 210 (e.g., a reflection network node) may receive an incident signal (e.g., from the transmitter 205) and may modulate the incident signal by reflecting (e.g., backscattering) the incident signal using different antenna loads which are switched over time in a periodic pattern. The low-power device 210 may perform the modulation by applying a time shift to this periodic pattern (e.g., incident signal) based on a set of data bits (e.g., data associated with the low-power device 210) and the reader 215 may, based on receiving the reflected signal, perform demodulation in the time domain by correlating (e.g., comparing) the received signal (e.g., the backscattered signal) with an internal clock of the reader 215.

In some cases, the transmitter 205 may output, and the low-power device 210 may receive and backscatter, a relatively complex waveform (e.g., multilevel waveforms) based on applying a complex (e.g., multilevel) periodic load switching pattern. In some cases, the transmitter 205 may apply the complex waveform to mitigate extraneous harmonics within the reflected waveform 225. In such cases, the low-power device 210 may perform time domain RM to produce a reflected signal (e.g., based on the received complex waveform). However, it may be ineffective and inefficient for the reader 215 to perform time domain demodulation to decode the data included within the reflected signal. For example, the reader 215 may be unable to effectively perform time domain demodulation for multilevel waveforms based on the reader 215 being unable to compare the multilevel waveform to an internal clock of the reader 215. Additionally, or alternatively, increasing a complexity of the modulation performed by the low-power device 210 (e.g., performing a frequency domain modulation instead of time domain modulation) may increase the complexity of the low-power device 210, and may correspondingly increase power consumption.

The techniques, methods, and devices described herein may support RM via subcarrier indices. For example, the low-power device 210 may, by utilizing RM via subcarrier indices, map data bits to one or more indices (e.g., frequency domain indices) of one or more subcarriers of the reflected signal. Accordingly, the reader 215 may perform frequency domain demodulation, which may enable the reader 215 to demodulate and decode complex (e.g., multilevel) waveforms, among other examples.

In some implementations, the transmitter 205 may output, and the low-power device 210 may obtain, an incident signal 220 in accordance with one or more initial energy-bearing REs (e.g., tones). That is, the low-power device 210 may receive the incident signal 220 over multiple REs, but only some of those REs may be energy-bearing REs or tones (e.g., energy may be concentrated in some REs, while other REs may not carry any energy). Accordingly, the low-power device 210 may perform RM via subcarrier indices. In such examples, the low-power device 210 may perform RM by applying periodic antenna load switching to the incident signal 220 at a rate proportional to a chip rate (e.g., clocking rate, among other examples) of the low-power device 210. For an example, the low-power device 210 may switch (e.g., increase or decrease) an applied antenna load a quantity of times per second, where the quantity is based on the chip rate of the low-power device 210.

In some implementations, the low-power device 210 may select (e.g., modify) the chip rate (fₘ) according to a set of data associated with the low-power device 210. For example, the set of data may indicate a location of the low-power device 210, a status of the low-power device 210, sensor data obtained by the low-power device 210, or the like. Accordingly, the low-power device 210 may apply the periodic load switching pattern to the incident signal 220 at the selected chip rate according to the set of data (e.g., modulating the incident signal 220 according to the chip rate) to generate a reflected waveform 225. In such examples, the low-power device 210 may, by modulating the incident signal 220 according to the chip rate, shift the initial energy-bearing REs of the incident signal 220 in the frequency domain. Accordingly, one or more energy-bearing REs of the reflected waveform 225 may occupy one or more different subcarriers than the initial energy-bearing REs.

In some implementations, the subcarriers containing the energy-bearing REs of the reflected waveform 225 may indicate the data of the low-power device 210. For example, the reader 215 may receive the reflected waveform 225 and correspondingly determine (e.g., detect, or calculate, among other examples) a frequency spectrum of the reflected waveform 225. In such examples, the frequency spectrum of the reflected waveform 225 may indicate the energy-bearing REs of the reflected waveform 225, and a frequency domain location of the energy-bearing REs may, according to a subcarrier data mapping (e.g., a mapping between occupied REs and corresponding data), represent a frequency domain mapping of the data of the low-power device 210.

In some implementations, the energy-bearing REs of the reflected waveform 225 may be associated with one or more modulation windows (e.g., frequency ranges). For example, the transmitter 205 may select the one or more initial energy-bearing REs of the incident signal 220 such that the shifted energy-bearing REs of the reflected waveform 225 may be included within a modulation window (e.g., an initial or primary modulation window). Additionally, or alternatively, the low-power device 210 may determine (e.g., detect or identify) the modulation window and may select the chip rate accordingly.

The transmitter 205 may utilize multiple modulation windows (e.g., multiple modulation windows a single OFDM symbol) for one or more repetitions of the incident signal 220 (e.g., to improve detection accuracy compared to a single incident signal). The transmitter 205 may determine a quantity of modulation windows based on a demodulation accuracy associated with demodulation at the reader 215 (e.g., based on feedback obtained from the reader 215 corresponding to demodulation of the reflected waveform 225). For example, the low-power device 210 may output the one or more repetitions of the low-power device 210 including one or more different (e.g., offset) initial energy-bearing REs. Accordingly, the low-power device 210 may, by applying the periodic load switching pattern, shift the energy-bearing REs of the repetitions of the incident signal 220 to generate repetitions of the reflected waveform 225 and to occupy one or more different subcarriers associated with one or more different modulation windows than the initial modulation window. In such examples, the reader 215 may demodulate the data associated with the repetitions of the reflected waveform 225 (e.g., perform demodulation for each modulation window) and combine the decisions (e.g., the demodulated signals) according to a majority vote rule, among other examples. Additionally, or alternatively, the transmitter 205 may serve additional devices (e.g., UEs) within one or more modulation windows different than an initial modulation window.

In some implementations, the transmitter 205 may output indications of one or more parameters (e.g., to the low-power device 210, the reader 215, or both) associated with the incident signal 220, the reflected waveform 225, or the periodic load switching pattern, among other examples. For example, the transmitter 205 may output signaling 230 (e.g., control signaling, among other examples) indicating the one or more parameters. For example, the signaling 230 may indicate the subcarrier mapping to the reader 215 such that the reader 215 may decode the data of the low-power device 210 from the reflected waveform 225. Additionally, or alternatively, the signaling 230 may include one or more modulation parameters indicating a group of subcarriers (e.g., a frequency range for the group of subcarriers) for the reader 215 to search within (e.g., max-energy search) for the occupied subcarriers, where the group of subcarriers is based on the chip rate of the low-power device 210. For example, the signaling 230 may indicate a frequency range including the index of one or more occupied REs. The signaling 230 may additionally indicate a quantity of modulation windows (e.g., non-overlapping modulation windows) utilized by the transmitter 205 and the low-power device 210, a modulation scheme for at least the incident signal 220, or both. In some examples, the signaling 230 may be a synchronization message.

In some implementations, the transmitter 205 may indicate a threshold shift offset value 235 to the low-power device 210 (e.g., via control signaling, among other examples). The threshold shift offset value 235 may include an indication of a threshold frequency offset for the resulting subcarriers corresponding to a threshold chip rate of the low-power device 210. The transmitter 205 may output the indication via the threshold shift offset value 235 based on a power leakage value associated with an isolation between the transmitter 205 and the reader 215. In some examples, a single network node may include the transmitter 205 and the reader 215 (e.g., a monostatic configuration). Accordingly, the power leakage value may be relatively high, and the transmitter 205 may indicate an offset value via the threshold shift offset value 235 to mitigate interference between the transmitter 205 and the reader 215. Additionally, or alternatively, the transmitter 205 and the reader 215 may be separate components (e.g., separate network nodes, or the like) and may be accordingly isolated (e.g., bistatic setting). In such examples, the threshold shift offset value 235 may indicate a threshold shift offset according to the bistatic setting.

The transmitter 205 may additionally indicate the threshold shift offset value 235 to the reader 215 via the signaling 230. In such examples, the reader 215 may utilize the shift value to identify a set of subcarriers (e.g., based on the threshold shift performed by the low-power device 210) to search within for the occupied subcarriers.

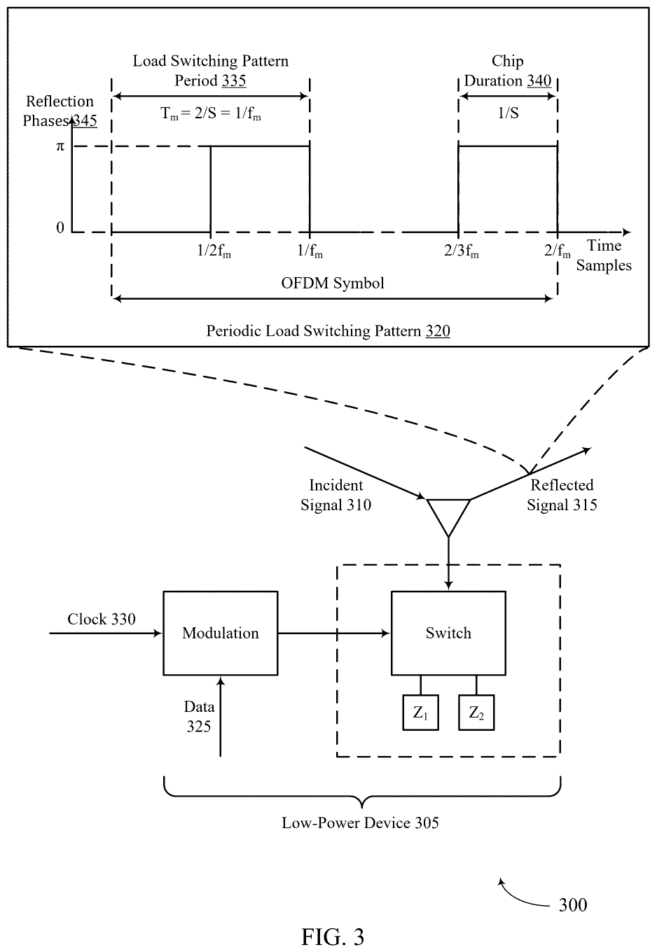

FIG. 3 shows an example of a block diagram 300 that supports reflection modulation via subcarrier indices in accordance with one or more aspects of the present disclosure. In some examples, the block diagram 300 may include aspects of the wireless communications system 100 and the wireless communications system 200.

In some cases, a low-power device 305 (e.g., an A-IoT device, or RIS, among other examples) may obtain an incident signal 310 (e.g., carrier wave). The incident signal may be defined by x(t) and may correspond to a carrier frequency f_{c}. In some examples, the low-power device 305 may generate and output a reflected signal 315 (e.g., backscattered communications) by applying a periodic load switching pattern 320, (e.g., given by s(t)), to the incident signal. The periodic load switching pattern may be based on a set of data 325 associated with the low-power device 305 (e.g., data to be transmitted by the low-power device 305). That is, the low-power device 305 may modulate the incident signal 310 with the set of data 325 by applying the periodic load switching pattern 320 according to a clock 330. For example, the low-power device 305 may apply the periodic load switching pattern 320 by switching between one or more different antenna loads (e.g., impedances such as an impedance Z1, and impedance Z2, or the like) at a frequency (e.g., periodicity) corresponding to at least the clock 330. A frequency domain representation of s(t) (e.g., Sₖ) may be defined by Equation 1, shown below.

$$s ( t ) = {\sum }_{ℓ = - ∞}^{∞} {a}_{ℓ} {e}^{j \frac{2 πℓ t}{{T}_{m}}} = {\sum }_{{ℓ = 1}_{ℓ : odd}}^{∞} \frac{2}{j π ℓ} ( {e}^{j \frac{2 πℓ t}{{T}_{m}}} - {e}^{- j \frac{2 πℓ t}{{T}_{m}}} ) \qquad ( 1 )$$

Additionally, or alternatively, a device may sample s(t). In such examples, s(t) may be defined by Equation 2, shown below.

$$s ( t ) {\vert}_{t = {nT}_{s}} = {\sum }_{{ℓ = 1}_{ℓ : odd}}^{∞} \frac{2}{j π ℓ} ( {e}^{j \frac{2 π ( ℓ M / 2 ) n}{N}} - {e}^{- j \frac{2 π ( ℓ M / 2 ) n}{N}} ) \qquad ( 2 )$$

In such examples, s(t) may be based on a load switching pattern period 335, (e.g., given by Tₘ), and a Fourier series coefficient αₗ, among other examples. The load switching pattern period 335 (e.g., Tₘ), may be given by Equation 3, shown below.

$${T}_{m} = \frac{2}{S} = \frac{1}{{f}_{m}} \qquad ( 3 )$$

In such examples, Tₘ may correspond to a chip rate fₘ, or M (e.g., a pulse rate, or pulse frequency, among other examples). The chip rate fₘ may additionally correspond to a chip duration 340 (e.g., pulse duration), S⁻¹. Accordingly, the low-power device 305 may generate the reflected signal 315 by modulating the incident signal 310 with a series of pulses corresponding to the periodic load switching pattern 320, where a frequency of the series of pulses is defined by the selected chip rate fₘ, and a duration of each pulse is defined by the corresponding chip duration. Each pulse of the series of pulses may begin at an interval corresponding to the chip rate fₘ. For example, a first pulse may begin at a time

$$\frac{1}{2 {f}_{m}}$$

and have a duration or one chip duration 340 (e.g., S⁻¹) such that the end of the pulse corresponds to a time

$$\frac{1}{2 {f}_{m}} .$$

Correspondingly, a second pulse may begin at a time

$$\frac{3}{2 {f}_{m}}$$

and end at a time

$$\frac{2}{{f}_{m}} .$$

In some examples, an amplitude of the periodic load switching pattern 320 may correspond to a magnitude of a reflection phase change 345 (e.g., a phase change of the reflected signal 315) resulting from the modulation. Additionally, or alternatively, the low-power device 305 may apply similar parameters (e.g., time intervals, amplitudes, chip durations, or the like) to perform reflection modulation using one or more complex (e.g., multilevel) waveforms.

As a result of the modulation, the reflected signal 315 may be defined by y(t)=s(t) x(t), where a frequency domain representation the reflected signal 315, Yₖ, may be given by Equation 4, shown below.

$${Y}_{k} = {\sum }_{{ℓ = 1}_{ℓ : odd}}^{∞} \frac{2}{j π ℓ} ( {X}_{k - ℓ M / 2} - {X}_{k + ℓ M / 2} ) \qquad ( 4 )$$

In such cases, Yₖ may correspond to the selected chip rate M (e.g., fₘ), and a Fourier series coefficient, [symbol] . For example, the reflected signal 315 may be defined by y(t)=s(t) x(t) and may correspond to a frequency of f_{c}±nfₘ, where fₘ is the chip rate of the low-power device 305. In such examples, the reflected signal 315 may have a modulation based on the periodic load switching pattern 320 according to the selected chip rate. As such, an overall modulation at the low-power device may be performed in the time domain (e.g., low-complexity modulation), while a reader may perform demodulation in the frequency domain (e.g., the reader may calculate the spectrum of the modulated signal).

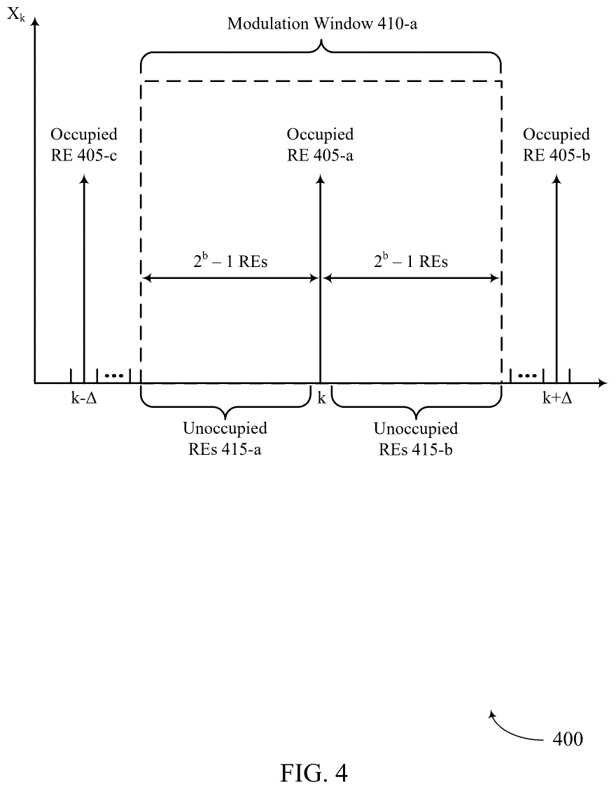

FIG. 4 shows an example of a signaling diagram 400 that supports reflection modulation via subcarrier indices in accordance with one or more aspects of the present disclosure. In some examples, the signaling diagram 400 may reflect aspects of the wireless communications system 100 and the wireless communications system 200.

In some implementations such as those further described herein with reference to FIG. 3, applying a periodic load switching pattern with an adjusted chip rate may shift one or more initial energy-bearing (i.e., occupied) REs to a different subcarrier (e.g., a desired subcarrier) location after reflection. A transmitter may additionally transmit an incident signal (e.g., initial signal, or carrier signal, among other examples) such that one or more occupied REs 405 (e.g., initial energy-bearing REs) of the initial signal may be shifted to one or more particular subcarrier locations (e.g., resulting subcarrier locations may be designed by the transmitter).

For example, the transmitter may output an incident signal including a first occupied RE 405-a. The first occupied RE 405-a may be associated with an initial frequency domain location (e.g., initial frequency, frequency resource, carrier frequency, or subcarrier index, among other examples), k. Additionally, or alternatively, a low-power device (e.g., an A-IoT device, a RIS, or the like) may select an adjusted chip rate, M, corresponding to the periodic load switching pattern based on a set of data associated with the low-power device. Accordingly, the low-power device may, based on obtaining the incident signal including the one or more initial occupied REs 405, modulate the incident signal by applying the periodic load switching pattern according to the selected chip rate M. In such examples, the low-power device may generate and output a reflected signal (e.g., backscattered signal) including one or more shifted occupied REs.

For example, the low-power device may obtain the incident signal including the first occupied RE 405-a, and the low-power device may modulate the incident signal to generate a reflected signal including the first occupied RE 405-a (e.g., at the frequency domain location k), a shifted occupied RE 405-b, a shifted occupied RE 405-c (e.g., a reflected image of the shifted occupied RE 405-b), or any combination thereof. For example, the low-power device may obtain the incident signal via the first occupied RE 405-a and may apply reflection modulation to produce at least the shifted occupied RE 405-b (e.g., a positive frequency image of the first occupied RE 405-a) and the shifted occupied RE 405-c (e.g., a negative frequency image of the first occupied RE 405-a). As such, the low-power device may output the reflected signal according to the one or more occupied REs 405. In such examples, the shifted occupied RE 405-b may have a frequency domain location (e.g., subcarrier index) of k+Δ, and the shifted occupied RE 405-c may have a frequency domain location of k−Δ, where Δ is an offset in frequency (e.g., a subcarrier spacing) from the index of the first occupied RE 405-a. In some examples, Δ may correspond to the selected chip rate M, where Δ is defined by

$$\frac{M}{2} ,$$

and M may be based on a quantity of bits, b, associated with the set of data of the low-power device (e.g., a quantity of bits to transmit). Accordingly, a frequency domain location (e.g., first harmonics) of one or more shifted occupied REs may be defined by

$$k \pm \frac{M}{2} ∈ k \pm \{ 0 , 1 , … , {2}^{b} - 1 \}$$

and a range of selectable chip rates (e.g., based on the quantity of bits to transmit) may be defined by M∈{0,2, . . . ,2(2^{b}−1)}, where a selectable chip rate, Mₘₐₓ, is given by Mₘₐₓ=2 (2^{b}−1). For an example, the first harmonics (e.g., occupied subcarrier indices) of a reflected signal associated with a data set of two bits is given by Table 1, shown below.

TABLE 1

| Bits | M | Image Index |
|---|---|---|
| 00 | 0 | k (no shift) |
| 01 | 2 | k ± 1 |
| 10 | 4 | k ± 2 |
| 11 | 6 | k ± 3 |

In some implementations, each of the one or more occupied REs 405 including the first occupied RE 405-a, the shifted occupied RE 405-b, the shifted occupied RE 405-c, or any combination thereof may be included within one or more modulation windows 410 (e.g., frequency ranges, or max-energy search regions, among other examples). In some examples, a reader device may search (e.g., perform a frequency domain demodulation) within the one or more modulation windows 410. Accordingly, the transmitter may output an indication of the one or more modulation windows 410 to the reader device, and the reader device may correspondingly demodulate and obtain the data associated with the low power device based on searching for the one or more occupied REs 405 within the one or more modulation windows 410.

The one or more occupied REs 405 may be included within a single modulation window 410, or within one or more adjacent modulation windows 410. In some examples, the one or more adjacent modulation windows 410 may be contiguous (e.g., corresponding to a contiguous frequency range) or separated by a frequency gap. Each of the one or more modulation windows 410 may include a quantity of 2^{b+1}−1 REs (e.g., when the initial occupied REs are included within the reflected signal), where a portion of the REs included within the one or more modulation windows 410 may be the one or more occupied REs 405, and an additional portion of the REs may be one or more unoccupied REs 415. For an example, a modulation window 410-a may include the first occupied RE 405-a, one or more unoccupied REs 415-a, and one or more unoccupied REs 415-b. In such examples, the one or more unoccupied REs 415-a and the one or more unoccupied REs 415-b may each include 2^{b}−1 REs.

In some implementations, a transmitter may utilize multiple modulation windows to output multiple repetitions of the incident signals including the one or more occupied REs 405 (e.g., to relatively improve detection accuracy compared to a single instance of the incident signal). For example, the transmitter may output a first instance of the incident signal including the one or more occupied REs 405 such that one or more shifted REs of the reflected signal are within a first modulation window of the one or more modulation windows 410. The transmitter may additionally output one or more repetitions of the incident signal including the one or more occupied REs 405 such that one or more shifted REs of the repetitions of the reflected signal are included within different modulation windows of the one or more modulation windows 410. Accordingly, a reader may receive the repetitions of the reflected signal and combine the decisions (e.g., apply majority rule) to demodulate the data.

A width (e.g., a frequency range) of each of the one or more modulation windows 410 may be based on the quantity of bits, b, and a Fourier series coefficient, [symbol] . For example, a width (e.g., frequency range, or bandwidth, among other examples) of the one or more adjacent modulation windows 410 may be given by Equation 5, shown below.

$$( k + \frac{ℓ {M}_{max}}{2} ) + 1 = ( k + Δ - \frac{ℓ {M}_{max}}{2} ) \qquad ( 5 )$$

In such examples, the frequency spacing (e.g., frequency offset, or subcarrier spacing, among other examples), Δ, for each reflected RE may be given by Δ=2 [symbol] (2^{b}−1)+1. Additionally, or alternatively, a width (e.g., frequency range, or bandwidth, among other examples) of a single modulation window 410 including each of the one or more occupied REs 405 may be given by Equation 6, shown below.

$$( k + {2}^{b} - 1 ) + 1 = ( k + Δ - \frac{ℓ {M}_{max}}{2} ) \qquad ( 6 )$$

where the frequency spacing for each reflected RE may be given by Δ=( [symbol] +1)(2^{b}−1)+1. Accordingly, a frequency separation (e.g., spacing) for each of the one or more occupied REs 405 included within the single modulation window 410 may be relatively smaller compared to a frequency separation of the one or more occupied REs 405 included within the adjacent modulation windows 410.

For an example, the reflected signal may have a bandwidth of 1 MHz, with a subcarrier spacing (e.g., a frequency spacing between the one or more occupied REs 405 based on a quantity of bits to transmit) of 15 kilohertz (KHz). Accordingly, the reflected signal may include 66 occupied REs. In such examples, the transmitter, the low-power device, the reader, or any combination thereof may utilize a quantity of modulation windows to modulate and demodulate the set of data associated with the low-power device, where the quantity of modulation windows is given in Table 2, shown below.

TABLE 2

| Quantity of Bits (b) | Quantity of Modulation Windows |
|---|---|
| 1 | 22 |
| 2 | 9 |
| 3 | 4 |
| 4 | 2 |
| 5 | 1 |
| ≥6 | N/A |

In such examples, the quantity of bits associated with the data of the low-power device may be based on the bandwidth and the subcarrier spacing of the reflected signal. The quantity of bits may further be based on the one or more occupied REs 405 of the reflected signal including both positive and negative images of the one or more occupied REs 405. In the above example, a threshold quantity of bits to be transmitted within the one or more modulation windows 410 may be based on the 1 MHz bandwidth, the 15 kHz subcarrier spacing of the reflected signal, and the positive and negative images of the obtained one or more occupied REs 405. In some examples, a reduction (e.g., in the threshold quantity of bits) may be due to images at both positive and negative frequences.

In some implementations described herein, the transmitter and the reader device may be isolated (e.g., bistatic), and a power leakage (e.g., signal power leakage, or signal interference, among other examples) may satisfy a threshold power leakage value (e.g., may be less than the threshold or may be negligible). Accordingly, the low-power device may refrain from applying a threshold shift offset to the reflected signal.

In some other examples (e.g., M-PSK modulation via sequence shift, for which the detector should run in frequency domain, among other examples), a power leakage value between the transmitter and the reader may satisfy a threshold power leakage value (e.g., may not be negligible). For example, the transmitter and the reader may be components of a single (e.g., shared) device (e.g., monostatic setting). In such examples, one or more initial occupied REs 405 of the incident signal may interfere with the one or more one or more occupied REs 405 of the reflected signal (e.g., based on the low-power device refraining from applying a threshold shift offset). Accordingly, the low power-device may apply a threshold shift offset to the one or more occupied REs 405 such that the reflected signal includes a shifted image of the one or more occupied REs 405 (e.g., indices of initial energy-bearing tones are not employed in modulation). For an example, the low-power device may obtain the first occupied RE 405-a corresponding to a frequency domain location k and low-power device may apply the threshold shift offset such that the reflected signal may include a reflected RE having a frequency domain location of k±1 (e.g., the initial frequency domain location with a threshold shift offset). Additionally, or alternatively, the transmitter may output, and the low-power device may obtain, an indication of the threshold shift offset (e.g., an indication of an offset value, an indication to apply the offset, or both) based on the power leakage value. The transmitter may indicate the threshold shift offset (e.g., if the transmitter and the reader are different network nodes and leakage from transmitter to reader is not significant such as in a bistatic setting) such that search of the reader may include the indices of the occupied REs in modulation (e.g., to relatively improve spectral efficiency).

In such examples, where the low-power device may apply a threshold shift offset, a frequency domain location (e.g., first harmonics) of one or more shifted occupied REs may be defined by

$$k \pm \frac{M}{2} ∈ k \pm \{ 1 , … , {2}^{b} \}$$

and a range of selectable chip rates (e.g., based on the quantity of bits to transmit) may be defined by M∈{2,4, . . . , 2^{b}+1} where a threshold (e.g., maximum) selectable chip rate, Mₘₐₓ, is given by Mₘₐₓ=2^{b+1}. For an example, the first harmonics (e.g., occupied subcarrier indices) of a reflected signal associated with a data set of two bits is given by Table 3, shown below.

TABLE 3

| Bits | M | Image Index |
|---|---|---|
| 00 | 2 | k ± 1 |
| 01 | 4 | k ± 2 |
| 10 | 6 | k ± 3 |
| 11 | 8 | k ± 4 |

Additionally, or alternatively, a width (e.g., a frequency range) of one or more modulation windows 410 associated with a threshold shift offset may be based on a quantity of bits, b, and a Fourier series coefficient, [symbol] . For example, a width (e.g., frequency range, or bandwidth, among other examples) of one or more adjacent modulation windows 410 may be given by Equation 7, shown below.

$$( k + \frac{ℓ {M}_{max}}{2} ) + 1 = ( k + Δ - \frac{ℓ {M}_{max}}{2} ) \qquad ( 7 )$$

In such examples, the frequency spacing for each reflected RE may be given by Δ=2 [symbol] 2\hat{ }b+1. Additionally, or alternatively, a width (e.g., frequency range, or bandwidth, among other examples) of a single modulation window 410 including each of the one or more occupied REs 405 may be given by Equation 8, shown below.

$$( k + {2}^{b} ) + 1 = ( k + Δ - \frac{ℓ {M}_{max}}{2} ) \qquad ( 8 )$$

where the frequency spacing for each reflected RE may be given by Δ=( [symbol] +1)2\hat{ }b+1. Each one or more modulation windows 410 may additionally include 2^{b} REs (e.g., occupied, and unoccupied REs).

For an example, the reflected signal may have a bandwidth of 1 MHz, with a subcarrier spacing (e.g., a frequency spacing between the one or more occupied REs 405 based on a quantity of bits to transmit) of 15 kHz. The reflected signal may additionally be associated with the threshold shift offset. Accordingly, the reflected signal may include 66 occupied REs. In such examples, the transmitter, the low-power device, the reader, or any combination thereof may utilize a quantity of modulation windows to modulate and demodulate the set of data associated with the low-power device, where the quantity of modulation windows is given in Table 4, shown below.

TABLE 4

| Quantity of Bits (b) | Quantity of Modulation Windows |
|---|---|
| 1 | 13 |
| 2 | 7 |
| 3 | 3 |
| 4 | 2 |
| 5 | 1 |
| ≥6 | N/A |

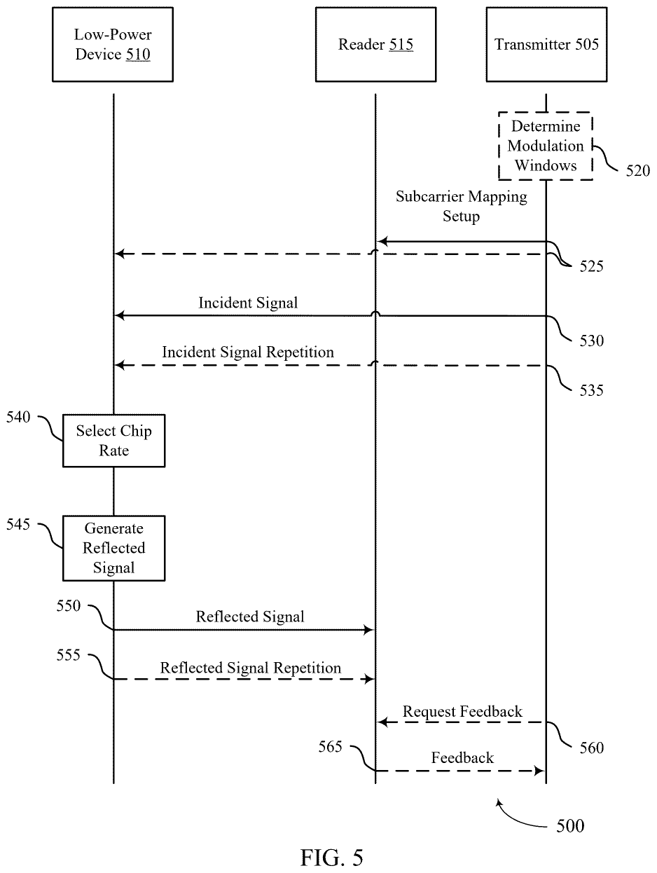

FIG. 5 shows an example of a process flow 500 that supports reflection modulation via subcarrier indices in accordance with one or more aspects of the present disclosure. Aspects of the process flow 500 may implement or be implemented by aspects of the wireless communications system 100 and the wireless communications system 200. For example, the wireless communications system 200 may include a transmitter 505 and a reader 515, which may be examples of the network entity 105, the UEs 115, or the like. The process flow 500 may additionally include a low-power device 510 (e.g., an A-IoT device, a RIS, or the like).

At 520, the transmitter 505 may determine (e.g., identify, or select, among other examples) a set of one or more modulation windows to utilize for reflection modulation communications. Each modulation window of the set of modulation windows may include a frequency range (e.g., a bandwidth) associated with one or more reflected (e.g., shifted in frequency) subcarriers, where a frequency domain location of the subcarriers represents a subcarrier data mapping. For example, an incident signal may include one or more initial energy-bearing REs (e.g., occupied REs) corresponding to an initial modulation window, and one or more repetitions of the incident signal may include one or more additional energy-bearing REs corresponding to different modulation windows. In some examples, the transmitter 505 may determine the set of modulation windows based on an accuracy threshold (e.g., a received signal demodulation accuracy threshold), a communication load, a traffic pattern, or any combination thereof, among other examples.

At 525, the transmitter 505 may output a subcarrier mapping setup message (e.g., via control signaling, among other examples). The subcarrier mapping setup message may include multiple parameters associated with the reflection modulation communications (e.g., share the modulation specifications with the receiver). For example, the subcarrier mapping setup message may include an indication of the modulation windows of 520 (e.g., frequency ranges of the modulation windows, center frequencies of the modulation windows, a quantity of utilized modulation windows, or the like) including the initial modulation window, one or more additional modulation windows, or both. The subcarrier mapping setup message of may indicate, to at least the reader 515, among which group of subcarriers to search for occupied subcarriers within (e.g., to perform a max-energy within). The subcarrier mapping setup message may additionally include an indication of a threshold shift offset (e.g., a threshold shift offset value, an indication to apply the threshold shift offset, or both), further defined herein with reference to FIG. 4. For example, the threshold shift offset may be based on a power leakage value between the transmitter 505 and the reader 515. The transmitter 505 may output the subcarrier mapping setup message to the low-power device 510, the reader 515, or both. For example, the transmitter 505 may indicate the threshold shift offset to the low-power device 510 via the subcarrier setup message.

At 530, the transmitter 505 may output, an incident signal. The incident signal may include at least one initial energy-bearing (e.g., occupied) RE. As described herein with reference to FIG. 4, the initial occupied RE may be associated with an initial frequency domain location (e.g., frequency, or frequency index, among other examples). In some examples, the transmitter 505 may select (e.g., select a set of resources for) the initial occupied RE in accordance with an initial modulation window such that, based on the reflection modulation, one or more reflected REs may occupy the initial modulation window.

At 535, the transmitter 505 may output one or more repetitions of the incident signal according to one or more different modulation windows. For example, the transmitter 505 may select the repetition of the incident signal such that one or more occupied REs of the incident signal may, based on the reflection modulation, occupy the different modulation windows. Additionally, or alternatively, the transmitter 505 may, within the one or more different modulation windows (e.g., within different modulation windows of a same OFDM symbol), communicate with (e.g., serve) one or more additional devices other than the low-power device 510 and the reader 515, such as one or more UEs.

At 540, the low-power device 510 may select a chip rate. As described further herein with reference to FIG. 3, the selected chip rate may correspond to a period (e.g., a pulse duration, among other examples) of a periodic load switching pattern. In some examples, the low-power device 510 may select the chip rate based on a set of data associated with low-power device 510. The low-power device 510 may additionally select the chip rate based on a quantity of bits (e.g., associated with the data of the low-power device 510) to transmit. For example, the low-power device 510 may select a chip rate such that the low-power device 510 may communicate (e.g., to the reader 515) four bits indicating a location of the low-power device 510. In some examples, a threshold chip rate may further correspond to the threshold shift offset indicated by the subcarrier mapping setup message of 530.

At 545, the low-power device 510 may generate a reflected signal in accordance with the selected chip rate. The low-power device 510 may, based on obtaining the incident signal of 530, the repetitions of the incident signal of 535, or both, modulate the received signals with the period load switching function with the set of data associated with the low-power device 510. In such examples, the periodic load switching pattern may include an antenna switching pattern, where multiple antenna loads (e.g., impedances) are applied via a switch to the incident signal of 530. Accordingly, the low-power device 510 may apply the antenna load switching pattern at a rate corresponding to the selected chip rate, which may modulate (e.g., encode) the incident signal with the data of the low-power device 510 and may correspondingly generate the reflected signal.

By applying the periodic load switching pattern to the incident signal, the modulation may shift the occupied REs of the incident signal to one or more different subcarrier locations (e.g., frequency domain locations, or indices, among other examples) based on the selected chip rate, and in accordance with the threshold shift offset. Accordingly, the reflected signal may include one or more energy-bearing (e.g., occupied) REs associated with a modulation window and one or more unoccupied REs, and a location (e.g., a frequency domain location) of the occupied REs may indicate the data of the low-power device 510 via a subcarrier data mapping.

At 550, the low-power device 510 may output the reflected signal (e.g., backscattered signal) including the occupied REs, the unoccupied REs, or both. The reader 515 may obtain the reflected signal and may determine (e.g., calculate, compute, or the like) a frequency content (e.g., frequency spectrum) of the reflected signal. For example, the reader 515 may perform a discrete Fourier transform (DFT), an inverse DFT (IDFT), or the like. Additionally, or alternatively, at 555, the low-power device 510 may output one or more repetitions of the reflected signal based on modulating the one or more repetitions of the incident signal according to the periodic load switching pattern and in accordance with the selected chip rate.

In such examples, the reader 515 may demodulate the reflected signal, the repetitions of the reflected signal, or both and obtain the data of the low-power device 510 according to the occupied subcarriers of the reflected signal (e.g., frequency domain locations of the occupied subcarriers) and based on the subcarrier data mapping. Additionally, or alternatively, the subcarrier data mapping may be indicated via the subcarrier mapping setup message of 525. The reader 515 may obtain the occupied REs based on searching (e.g., monitoring, among other examples) within the indicated modulation windows.

At 560, the transmitter 505 may request feedback message from the reader 515 indicating whether the demodulation was successful. At 565, the reader 515 may output (e.g., autonomously or based at least in part on the feedback request message of 560) a feedback message indicating whether the demodulation was successful. Additionally, or alternatively, the reader 515 may output an indication of a demodulation accuracy, an indication of the demodulated data, or any combination thereof such that the transmitter 505 may determine to output the multiple repetitions of the incident signal within multiple modulation windows in accordance with receiving the indication. The reader 515 may output the feedback message in response to a request message from the transmitter 505 requesting feedback of demodulation accuracy, among other examples.

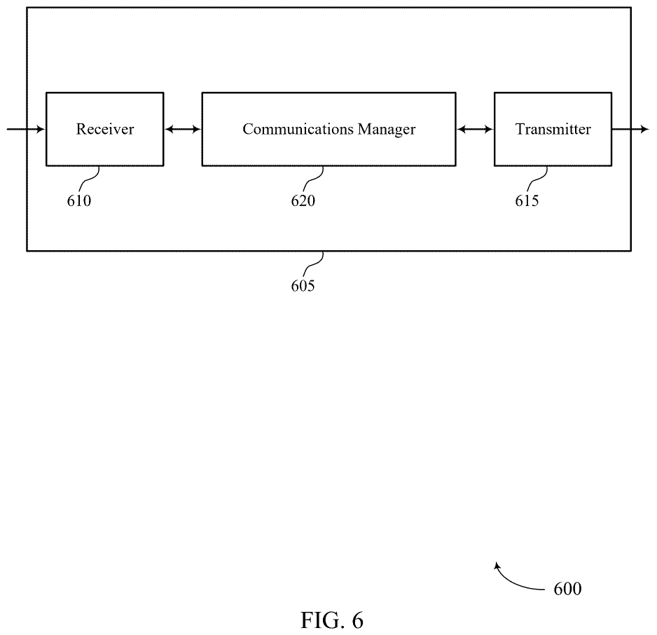

FIG. 6 shows a block diagram 600 of a device 605 that supports reflection modulation via subcarrier indices in accordance with one or more aspects of the present disclosure. The device 605 may be an example of aspects of a wireless device as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to reflection modulation via subcarrier indices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to reflection modulation via subcarrier indices). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of reflection modulation via subcarrier indices as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for obtaining an incident signal. The communications manager 620 is capable of, configured to, or operable to support a means for selecting a chip rate according to a subcarrier data mapping. The communications manager 620 is capable of, configured to, or operable to support a means for generating a reflected signal in accordance with a periodic load switching pattern applied to the incident signal at a frequency corresponding to the selected chip rate. The communications manager 620 is capable of, configured to, or operable to support a means for outputting the reflected signal, where a first subset of REs of the reflected signal are energy-bearing REs that satisfy the subcarrier data mapping, and a second subset of REs of the reflected signal are non-energy-bearing REs that satisfy the subcarrier data mapping.

Additionally, or alternatively, the communications manager 620 may support wireless communications in accordance with examples as disclosed herein. For example, the communications manager 620 is capable of, configured to, or operable to support a means for outputting, via a first wireless device to a third wireless device, an incident signal including one or more initial energy-bearing REs. The communications manager 620 is capable of, configured to, or operable to support a means for outputting, to at least one of the first wireless device or the third wireless device, an indication of a subcarrier data mapping, the subcarrier data mapping corresponding to a set of data associated with the first wireless device.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced power consumption and more efficient utilization of communication resources, among other advantages.

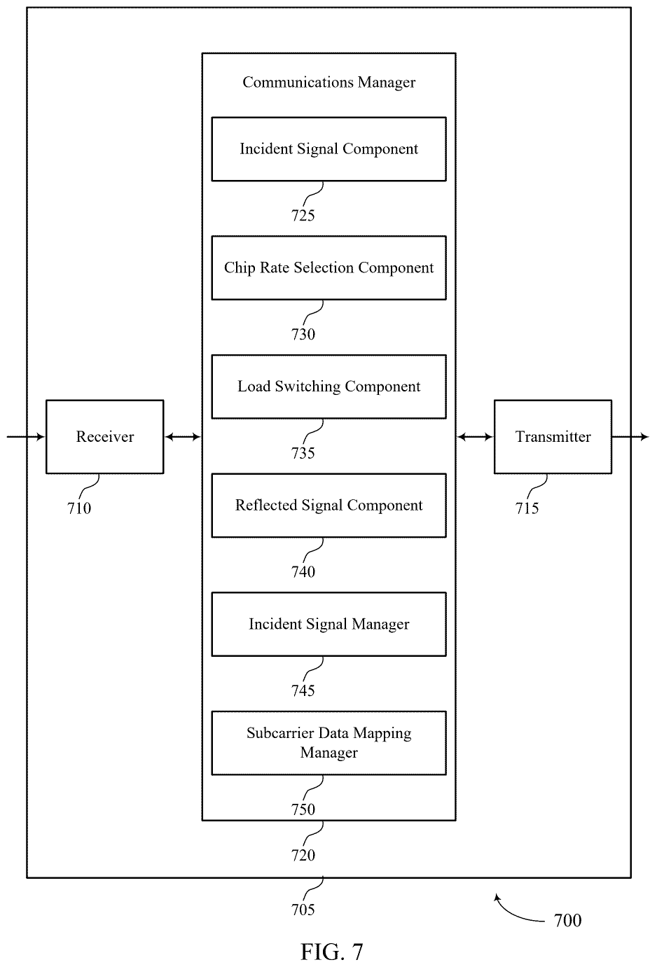

FIG. 7 shows a block diagram 700 of a device 705 that supports reflection modulation via subcarrier indices in accordance with one or more aspects of the present disclosure. The device 705 may be an example of aspects of a device 605 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to reflection modulation via subcarrier indices). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to reflection modulation via subcarrier indices). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of reflection modulation via subcarrier indices as described herein. For example, the communications manager 720 may include an incident signal component 725, a chip rate selection component 730, a load switching component 735, a reflected signal component 740, an incident signal manager 745, a subcarrier data mapping manager 750, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The incident signal component 725 is capable of, configured to, or operable to support a means for obtaining an incident signal. The chip rate selection component 730 is capable of, configured to, or operable to support a means for selecting a chip rate according to a subcarrier data mapping. The load switching component 735 is capable of, configured to, or operable to support a means for generating a reflected signal in accordance with a periodic load switching pattern applied to the incident signal at a frequency corresponding to the selected chip rate. The reflected signal component 740 is capable of, configured to, or operable to support a means for outputting the reflected signal, where a first subset of REs of the reflected signal are energy-bearing REs that satisfy the subcarrier data mapping, and a second subset of REs of the reflected signal are non-energy-bearing REs that satisfy the subcarrier data mapping.

Additionally, or alternatively, the communications manager 720 may support wireless communications in accordance with examples as disclosed herein. The incident signal manager 745 is capable of, configured to, or operable to support a means for outputting, via a first wireless device to a third wireless device, an incident signal including one or more initial energy-bearing REs. The subcarrier data mapping manager 750 is capable of, configured to, or operable to support a means for outputting, to at least one of the first wireless device or the third wireless device, an indication of a subcarrier data mapping, the subcarrier data mapping corresponding to a set of data associated with the first wireless device.

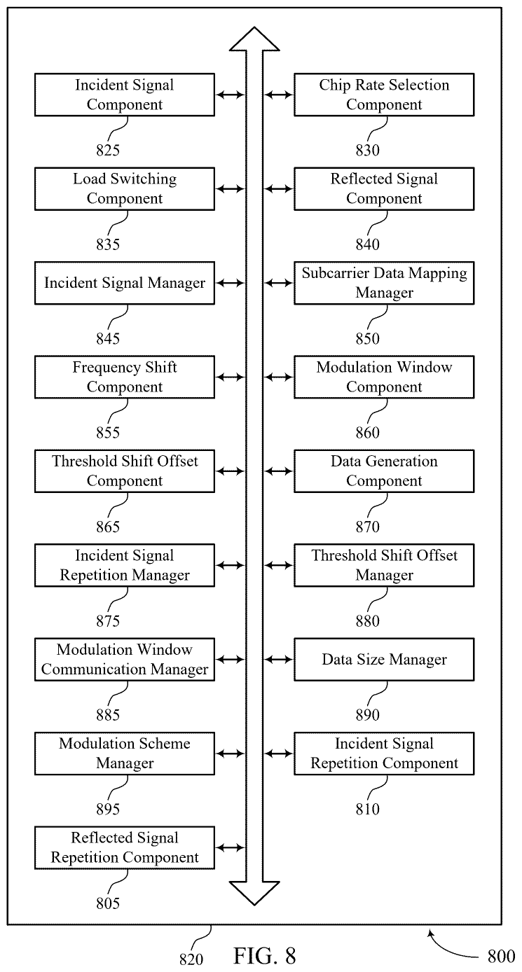

FIG. 8 shows a block diagram 800 of a communications manager 820 that supports reflection modulation via subcarrier indices in accordance with one or more aspects of the present disclosure. The communications manager 820 may be an example of aspects of a communications manager 620, a communications manager 720, or both, as described herein. The communications manager 820, or various components thereof, may be an example of means for performing various aspects of reflection modulation via subcarrier indices as described herein. For example, the communications manager 820 may include an incident signal component 825, a chip rate selection component 830, a load switching component 835, a reflected signal component 840, an incident signal manager 845, a subcarrier data mapping manager 850, a frequency shift component 855, a modulation window component 860, a threshold shift offset component 865, a data generation component 870, an incident signal repetition manager 875, a threshold shift offset manager 880, a modulation window communication manager 885, a data size manager 890, a modulation scheme manager 895, an incident signal repetition component 810, a reflected signal repetition component 805, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The incident signal component 825 is capable of, configured to, or operable to support a means for obtaining an incident signal. The chip rate selection component 830 is capable of, configured to, or operable to support a means for selecting a chip rate according to a subcarrier data mapping. The load switching component 835 is capable of, configured to, or operable to support a means for generating a reflected signal in accordance with a periodic load switching pattern applied to the incident signal at a frequency corresponding to the selected chip rate. The reflected signal component 840 is capable of, configured to, or operable to support a means for outputting the reflected signal, where a first subset of REs of the reflected signal are energy-bearing REs that satisfy the subcarrier data mapping, and a second subset of REs of the reflected signal are non-energy-bearing REs that satisfy the subcarrier data mapping.

In some examples, the incident signal is obtained via one or more initial energy-bearing REs, and the frequency shift component 855 is capable of, configured to, or operable to support a means for performing, by applying the periodic load switching pattern, a frequency domain shift to the one or more initial energy-bearing REs according to the subcarrier data mapping, where one or more shifted energy-bearing REs include the first subset of REs.

In some examples, a threshold chip rate corresponds to a threshold shifting offset. In some examples, performing the frequency domain shift is in accordance with the threshold shifting offset.

In some examples, the load switching component 835 is capable of, configured to, or operable to support a means for communicating a set of data associated with the first wireless device in accordance with applying the periodic load switching pattern, where the set of data is indicated by a frequency domain location of the first subset of REs.

In some examples, the modulation window component 860 is capable of, configured to, or operable to support a means for determining a first modulation window, where selecting the chip rate is in accordance with the first modulation window.

In some examples, the energy-bearing REs, the non-energy-bearing REs, or both are included within at least the first modulation window.

In some examples, a width of the first modulation window is in accordance with a bandwidth, a subcarrier spacing, or both corresponding to a communication channel of the first wireless device. In some examples, the width of the first modulation window is further in accordance with the subcarrier data mapping.

In some examples, the modulation window component 860 is capable of, configured to, or operable to support a means for determining one or more second modulation windows, where a quantity of modulation windows including a first modulation window and the one or more second modulation windows corresponds to a quantity of data bits associated with the first wireless device, a bandwidth, a subcarrier spacing, or any combination thereof corresponding to a communication channel of the first wireless device.

In some examples, the incident signal repetition component 810 is capable of, configured to, or operable to support a means for obtaining, within the one or more second modulation windows, one or more repetitions of the incident signal, where the one or more repetitions of the incident signal include one or more REs that are different than one or more REs of the incident signal. In some examples, the reflected signal repetition component 805 is capable of, configured to, or operable to support a means for outputting one or more additional reflected signals within the one or more second modulation windows in accordance with receiving the one or more repetitions of the incident signal and applying the periodic load switching pattern to the one or more repetitions of the incident signal.

In some examples, each repetition of the one or more repetitions of the incident signal corresponds to a different modulation window of the one or more second modulation windows.

In some examples, a first portion of the energy-bearing REs, the non-energy-bearing REs, or both are included within a first modulation window. In some examples, a second portion of the energy-bearing REs, the non-energy-bearing REs, or both are included within the one or more second modulation windows.

In some examples, the threshold shift offset component 865 is capable of, configured to, or operable to support a means for receiving an indication of a threshold shifting offset in accordance with a power leakage value, where selecting the chip rate is in accordance with the threshold shifting offset.

In some examples, the data generation component 870 is capable of, configured to, or operable to support a means for generating a set of data, where selecting the chip rate is in accordance with the set of data.

Additionally, or alternatively, the communications manager 820 may support wireless communications in accordance with examples as disclosed herein. The incident signal manager 845 is capable of, configured to, or operable to support a means for outputting, via a first wireless device to a third wireless device, an incident signal including one or more initial energy-bearing REs. The subcarrier data mapping manager 850 is capable of, configured to, or operable to support a means for outputting, to at least one of the first wireless device or the third wireless device, an indication of a subcarrier data mapping, the subcarrier data mapping corresponding to a set of data associated with the first wireless device.

In some examples, the incident signal is output during a first modulation window, and the incident signal repetition manager 875 is capable of, configured to, or operable to support a means for outputting, within one or more second modulation windows that are non-overlapping with the first modulation window, one or more repetitions of the incident signal.

In some examples, a quantity of the one or more second modulation windows is determined in accordance with a threshold demodulation accuracy.

In some examples, the threshold shift offset manager 880 is capable of, configured to, or operable to support a means for outputting an indication of a threshold shifting offset in accordance with a power leakage value.

In some examples, the threshold shift offset manager 880 is capable of, configured to, or operable to support a means for outputting an indication that the subcarrier data mapping includes an initial energy-bearing RE associated with the incident signal, one or more shifted energy-bearing REs including one or more frequency domain shifts of the initial energy-bearing RE, or any combination thereof in accordance with the threshold shifting offset.

In some examples, the incident signal is output during a first modulation window, and the modulation window communication manager 885 is capable of, configured to, or operable to support a means for communicating, within one or more second modulation windows that are non-overlapping with the first modulation window, additional signaling with one or more additional devices.

In some examples, the one or more additional devices include UEs.

In some examples, the data size manager 890 is capable of, configured to, or operable to support a means for outputting an indication of a quantity of bits associated with the first wireless device.

In some examples, the indication of the quantity of bits includes a synchronization message.

In some examples, a quantity of modulation windows associated with communication at the first wireless device corresponds to a quantity of data bits associated with the first wireless device, a bandwidth, a subcarrier spacing, or any combination thereof.

In some examples, the modulation scheme manager 895 is capable of, configured to, or operable to support a means for selecting a modulation scheme corresponding to at least the incident signal. In some examples, the modulation scheme manager 895 is capable of, configured to, or operable to support a means for outputting an indication of the modulation scheme in accordance with selecting the modulation scheme and in accordance with applying the modulation scheme for at least the incident signal.

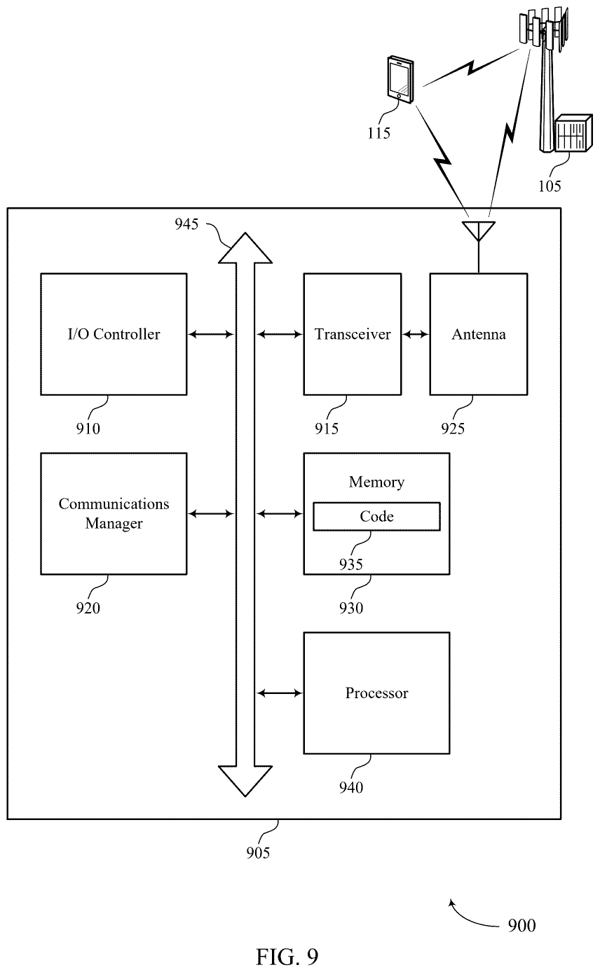

FIG. 9 shows a diagram of a system 900 including a device 905 that supports reflection modulation via subcarrier indices in accordance with one or more aspects of the present disclosure. The device 905 may be an example of or include components of a device 605, a device 705, or a wireless device as described herein. The device 905 may include components for bi-directional voice and data communications including components for transmitting and receiving communications, such as a communications manager 920, an I/O controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include RAM and ROM. The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a BIOS which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting reflection modulation via subcarrier indices). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for obtaining an incident signal. The communications manager 920 is capable of, configured to, or operable to support a means for selecting a chip rate according to a subcarrier data mapping. The communications manager 920 is capable of, configured to, or operable to support a means for generating a reflected signal in accordance with a periodic load switching pattern applied to the incident signal at a frequency corresponding to the selected chip rate. The communications manager 920 is capable of, configured to, or operable to support a means for outputting the reflected signal, where a first subset of REs of the reflected signal are energy-bearing REs that satisfy the subcarrier data mapping, and a second subset of REs of the reflected signal are non-energy-bearing REs that satisfy the subcarrier data mapping.

Additionally, or alternatively, the communications manager 920 may support wireless communications in accordance with examples as disclosed herein. For example, the communications manager 920 is capable of, configured to, or operable to support a means for outputting, via a first wireless device to a third wireless device, an incident signal including one or more initial energy-bearing REs. The communications manager 920 is capable of, configured to, or operable to support a means for outputting, to at least one of the first wireless device or the third wireless device, an indication of a subcarrier data mapping, the subcarrier data mapping corresponding to a set of data associated with the first wireless device.

By including or configuring the communications manager 920 in accordance with examples as described herein, the device 905 may support techniques for reduced power consumption, more efficient utilization of communication resources, improved coordination between devices, and improved utilization of processing capability, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of reflection modulation via subcarrier indices as described herein, or the at least one processor 940 and the at least one memory 930 may be otherwise configured to, individually or collectively, perform or support such operations.

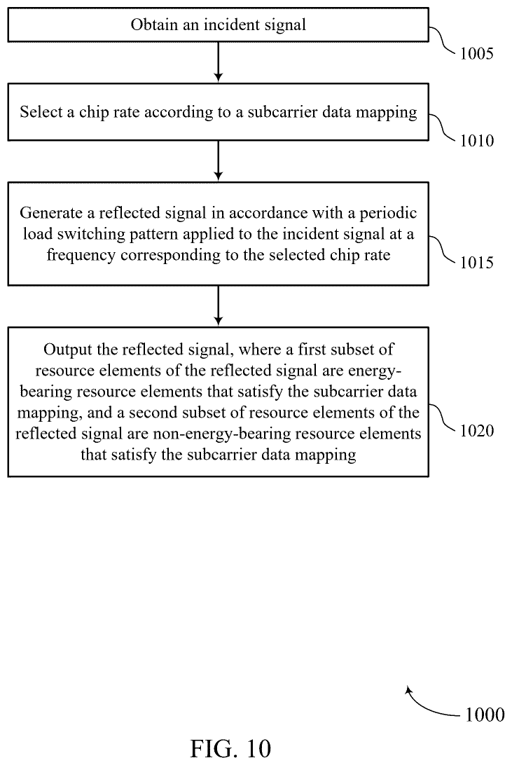

FIG. 10 shows a flowchart illustrating a method 1000 that supports reflection modulation via subcarrier indices in accordance with one or more aspects of the present disclosure. The operations of the method 1000 may be implemented by a wireless device or its components as described herein. For example, the operations of the method 1000 may be performed by a wireless device as described with reference to FIGS. 1 through 9. In some examples, a wireless device may execute a set of instructions to control the functional elements of the wireless device to perform the described functions. Additionally, or alternatively, the wireless device may perform aspects of the described functions using special-purpose hardware.

At 1005, the method may include obtaining an incident signal. The operations of 1005 may be performed in accordance with examples as disclosed herein. In some examples, aspects of the operations of 1005 may be performed by an incident signal component 825 as described with reference to FIG. 8.

At 1010, the method may include selecting a chip rate according to a subcarrier data mapping. The operations of 1010 may be performed in accordance with examples as disclosed herein. In some examples, aspects of the operations of 1010 may be performed by a chip rate selection component 830 as described with reference to FIG. 8.

At 1015, the method may include generating a reflected signal in accordance with a periodic load switching pattern applied to the incident signal at a frequency corresponding to the selected chip rate. The operations of 1015 may be performed in accordance with examples as disclosed herein. In some examples, aspects of the operations of 1015 may be performed by a load switching component 835 as described with reference to FIG. 8.

At 1020, the method may include outputting the reflected signal, where a first subset of REs of the reflected signal are energy-bearing REs that satisfy the subcarrier data mapping, and a second subset of REs of the reflected signal are non-energy-bearing REs that satisfy the subcarrier data mapping. The operations of 1020 may be performed in accordance with examples as disclosed herein. In some examples, aspects of the operations of 1020 may be performed by a reflected signal component 840 as described with reference to FIG. 8.

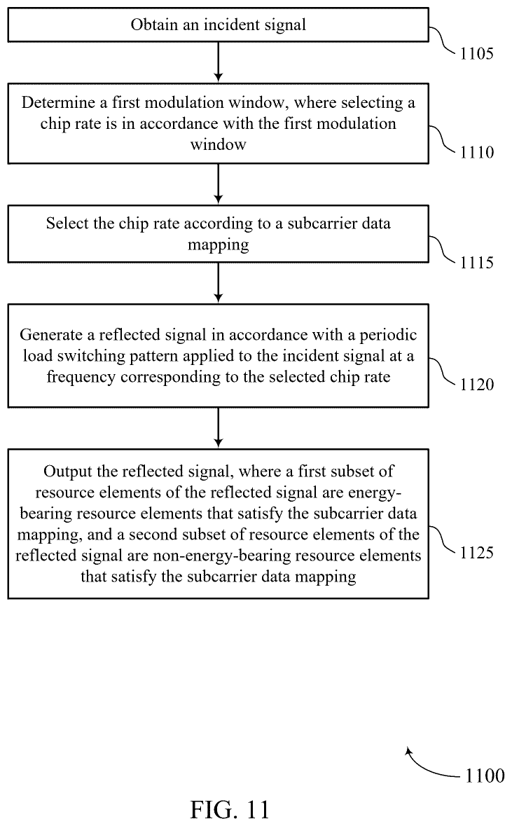

FIG. 11 shows a flowchart illustrating a method 1100 that supports reflection modulation via subcarrier indices in accordance with one or more aspects of the present disclosure. The operations of the method 1100 may be implemented by a wireless device or its components as described herein. For example, the operations of the method 1100 may be performed by a wireless device as described with reference to FIGS. 1 through 9. In some examples, a wireless device may execute a set of instructions to control the functional elements of the wireless device to perform the described functions. Additionally, or alternatively, the wireless device may perform aspects of the described functions using special-purpose hardware.

At 1105, the method may include obtaining an incident signal. The operations of 1105 may be performed in accordance with examples as disclosed herein. In some examples, aspects of the operations of 1105 may be performed by an incident signal component 825 as described with reference to FIG. 8.

At 1110, the method may include determining a first modulation window, where selecting a chip rate is in accordance with the first modulation window. The operations of 1110 may be performed in accordance with examples as disclosed herein. In some examples, aspects of the operations of 1110 may be performed by a modulation window component 860 as described with reference to FIG. 8.

At 1115, the method may include selecting the chip rate according to a subcarrier data mapping and determining the modulation window. The operations of 1115 may be performed in accordance with examples as disclosed herein. In some examples, aspects of the operations of 1115 may be performed by a chip rate selection component 830 as described with reference to FIG. 8.

At 1120, the method may include generating a reflected signal in accordance with a periodic load switching pattern applied to the incident signal at a frequency corresponding to the selected chip rate. The operations of 1120 may be performed in accordance with examples as disclosed herein. In some examples, aspects of the operations of 1120 may be performed by a load switching component 835 as described with reference to FIG. 8.

At 1125, the method may include outputting the reflected signal, where a first subset of REs of the reflected signal are energy-bearing REs that satisfy the subcarrier data mapping, and a second subset of REs of the reflected signal are non-energy-bearing REs that satisfy the subcarrier data mapping. The operations of 1125 may be performed in accordance with examples as disclosed herein. In some examples, aspects of the operations of 1125 may be performed by a reflected signal component 840 as described with reference to FIG. 8.

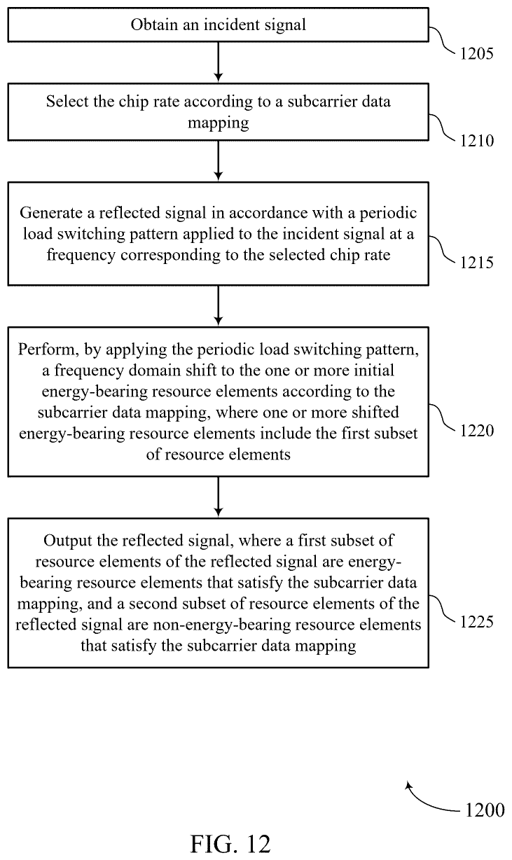

FIG. 12 shows a flowchart illustrating a method 1200 that supports reflection modulation via subcarrier indices in accordance with one or more aspects of the present disclosure. The operations of the method 1200 may be implemented by a wireless device or its components as described herein. For example, the operations of the method 1200 may be performed by a wireless device as described with reference to FIGS. 1 through 9. In some examples, a wireless device may execute a set of instructions to control the functional elements of the wireless device to perform the described functions. Additionally, or alternatively, the wireless device may perform aspects of the described functions using special-purpose hardware.

At 1205, the method may include obtaining an incident signal. The operations of 1205 may be performed in accordance with examples as disclosed herein. In some examples, aspects of the operations of 1205 may be performed by an incident signal component 825 as described with reference to FIG. 8.

At 1210, the method may include selecting a chip rate according to a subcarrier data mapping. The operations of 1210 may be performed in accordance with examples as disclosed herein. In some examples, aspects of the operations of 1210 may be performed by a chip rate selection component 830 as described with reference to FIG. 8.

At 1215, the method may include generating a reflected signal in accordance with a periodic load switching pattern applied to the incident signal at a frequency corresponding to the selected chip rate. The operations of 1215 may be performed in accordance with examples as disclosed herein. In some examples, aspects of the operations of 1215 may be performed by a load switching component 835 as described with reference to FIG. 8.

At 1220, the method may include performing, by applying the periodic load switching pattern, a frequency domain shift to the one or more initial energy-bearing REs according to the subcarrier data mapping, where one or more shifted energy-bearing REs include the first subset of REs. The operations of 1220 may be performed in accordance with examples as disclosed herein. In some examples, aspects of the operations of 1220 may be performed by a frequency shift component 855 as described with reference to FIG. 8.

At 1225, the method may include outputting the reflected signal, where a first subset of REs of the reflected signal are energy-bearing REs that satisfy the subcarrier data mapping, and a second subset of REs of the reflected signal are non-energy-bearing REs that satisfy the subcarrier data mapping. The operations of 1225 may be performed in accordance with examples as disclosed herein. In some examples, aspects of the operations of 1225 may be performed by a reflected signal component 840 as described with reference to FIG. 8.

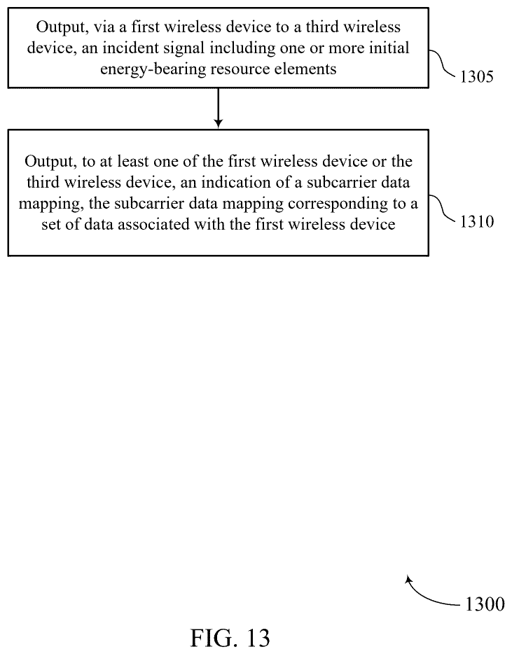

FIG. 13 shows a flowchart illustrating a method 1300 that supports reflection modulation via subcarrier indices in accordance with one or more aspects of the present disclosure. The operations of the method 1300 may be implemented by a wireless device or its components as described herein. For example, the operations of the method 1300 may be performed by a wireless device as described with reference to FIGS. 1 through 9. In some examples, a wireless device may execute a set of instructions to control the functional elements of the wireless device to perform the described functions. Additionally, or alternatively, the wireless device may perform aspects of the described functions using special-purpose hardware.

At 1305, the method may include outputting, via a first wireless device to a third wireless device, an incident signal including one or more initial energy-bearing REs. The operations of 1305 may be performed in accordance with examples as disclosed herein. In some examples, aspects of the operations of 1305 may be performed by an incident signal manager 845 as described with reference to FIG. 8.

At 1310, the method may include outputting, to at least one of the first wireless device or the third wireless device, an indication of a subcarrier data mapping, the subcarrier data mapping corresponding to a set of data associated with the first wireless device. The operations of 1310 may be performed in accordance with examples as disclosed herein. In some examples, aspects of the operations of 1310 may be performed by a subcarrier data mapping manager 850 as described with reference to FIG. 8.

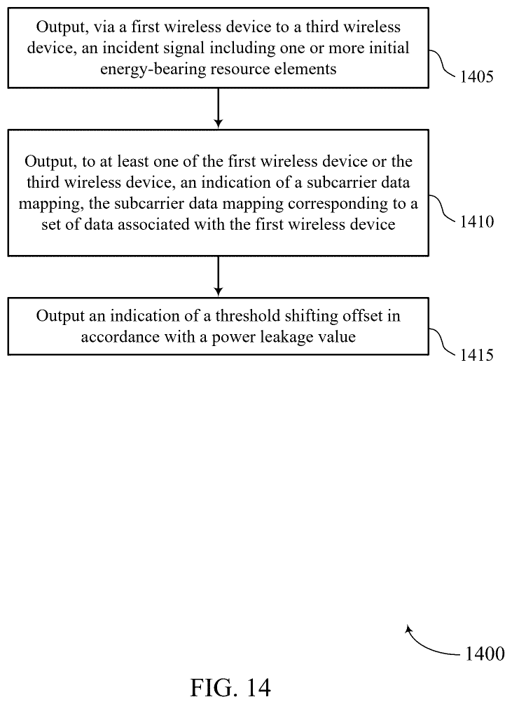

FIG. 14 shows a flowchart illustrating a method 1400 that supports reflection modulation via subcarrier indices in accordance with one or more aspects of the present disclosure. The operations of the method 1400 may be implemented by a wireless device or its components as described herein. For example, the operations of the method 1400 may be performed by a wireless device as described with reference to FIGS. 1 through 9. In some examples, a wireless device may execute a set of instructions to control the functional elements of the wireless device to perform the described functions. Additionally, or alternatively, the wireless device may perform aspects of the described functions using special-purpose hardware.

At 1405, the method may include outputting, via a first wireless device to a third wireless device, an incident signal including one or more initial energy-bearing REs. The operations of 1405 may be performed in accordance with examples as disclosed herein. In some examples, aspects of the operations of 1405 may be performed by an incident signal manager 845 as described with reference to FIG. 8.

At 1410, the method may include outputting, to at least one of the first wireless device or the third wireless device, an indication of a subcarrier data mapping, the subcarrier data mapping corresponding to a set of data associated with the first wireless device. The operations of 1410 may be performed in accordance with examples as disclosed herein. In some examples, aspects of the operations of 1410 may be performed by a subcarrier data mapping manager 850 as described with reference to FIG. 8.

At 1415, the method may include outputting an indication of a threshold shifting offset in accordance with a power leakage value. The operations of 1415 may be performed in accordance with examples as disclosed herein. In some examples, aspects of the operations of 1415 may be performed by a threshold shift offset manager 880 as described with reference to FIG. 8.

The following provides an overview of aspects of the present disclosure:

Aspect 1: A method for wireless communications by a first wireless device, comprising: obtaining an incident signal; selecting a chip rate according to a subcarrier data mapping; generating a reflected signal in accordance with a periodic load switching pattern applied to the incident signal at a frequency corresponding to the selected chip rate; and outputting the reflected signal, wherein a first subset of REs of the reflected signal are energy-bearing REs that satisfy the subcarrier data mapping, and a second subset of REs of the reflected signal are non-energy-bearing REs that satisfy the subcarrier data mapping.

Aspect 2: The method of aspect 1, wherein the incident signal is obtained via one or more initial energy-bearing REs, the method further comprising: performing, by applying the periodic load switching pattern, a frequency domain shift to the one or more initial energy-bearing REs according to the subcarrier data mapping, wherein one or more shifted energy-bearing REs comprise the first subset of REs.

Aspect 3: The method of aspect 2, wherein a threshold chip rate corresponds to a threshold shifting offset, and performing the frequency domain shift is in accordance with the threshold shifting offset.

Aspect 4: The method of any of aspects 1 through 3, further comprising: communicating a set of data associated with the first wireless device in accordance with applying the periodic load switching pattern, wherein the set of data is indicated by a frequency domain location of the first subset of REs.

Aspect 5: The method of any of aspects 1 through 4, further comprising: determining a first modulation window, wherein selecting the chip rate is in accordance with the first modulation window.

Aspect 6: The method of aspect 5, wherein the energy-bearing REs, the non-energy-bearing REs, or both are included within at least the first modulation window.

Aspect 7: The method of any of aspects 5 through 6, wherein a width of the first modulation window is in accordance with a bandwidth, a subcarrier spacing, or both corresponding to a communication channel of the first wireless device, and the width of the first modulation window is further in accordance with the subcarrier data mapping.

Aspect 8: The method of any of aspects 1 through 4, further comprising: determining one or more second modulation windows, wherein a quantity of modulation windows including a first modulation window and the one or more second modulation windows corresponds to a quantity of data bits associated with the first wireless device, a bandwidth, a subcarrier spacing, or any combination thereof corresponding to a communication channel of the first wireless device.

Aspect 9: The method of aspect 8, further comprising: obtaining, within the one or more second modulation windows, one or more repetitions of the incident signal, wherein the one or more repetitions of the incident signal comprise one or more REs that are different than one or more REs of the incident signal; and outputting one or more additional reflected signals within the one or more second modulation windows in accordance with receiving the one or more repetitions of the incident signal and applying the periodic load switching pattern to the one or more repetitions of the incident signal.

Aspect 10: The method of aspect 9, wherein each repetition of the one or more repetitions of the incident signal corresponds to a different modulation window of the one or more second modulation windows.

Aspect 11: The method of aspect 8, wherein a first portion of the energy-bearing REs, the non-energy-bearing REs, or both are included within a first modulation window, and a second portion of the energy-bearing REs, the non-energy-bearing REs, or both are included within the one or more second modulation windows.

Aspect 12: The method of any of aspects 1 through 11, further comprising: receiving an indication of a threshold shifting offset in accordance with a power leakage value, wherein selecting the chip rate is in accordance with the threshold shifting offset.

Aspect 13: The method of any of aspects 1 through 12, further comprising: generating a set of data, wherein selecting the chip rate is in accordance with the set of data.

Aspect 14: A method for wireless communications by a second wireless device, comprising: outputting, via a first wireless device to a third wireless device, an incident signal comprising one or more initial energy-bearing REs; and outputting, to at least one of the first wireless device or the third wireless device, an indication of a subcarrier data mapping, the subcarrier data mapping corresponding to a set of data associated with the first wireless device.

Aspect 15: The method of aspect 14, wherein the incident signal is output during a first modulation window, the method further comprising: outputting, within one or more second modulation windows that are non-overlapping with the first modulation window, one or more repetitions of the incident signal.

Aspect 16: The method of aspect 15, wherein a quantity of the one or more second modulation windows is determined in accordance with a threshold demodulation accuracy.

Aspect 17: The method of any of aspects 14 through 16, further comprising: outputting an indication of a threshold shifting offset in accordance with a power leakage value.

Aspect 18: The method of aspect 17, further comprising: outputting an indication that the subcarrier data mapping includes an initial energy-bearing RE associated with the incident signal, one or more shifted energy-bearing REs comprising one or more frequency domain shifts of the initial energy-bearing RE, or any combination thereof in accordance with the threshold shifting offset.

Aspect 19: The method of aspect 14, wherein the incident signal is output during a first modulation window, the method further comprising: communicating, within one or more second modulation windows that are non-overlapping with the first modulation window, additional signaling with one or more additional devices.

Aspect 20: The method of aspect 19, wherein the one or more additional devices comprise UEs.

Aspect 21: The method of any of aspects 14 through 20, further comprising: outputting an indication of a quantity of bits associated with the first wireless device.

Aspect 22: The method of aspect 21, wherein the indication of the quantity of bits comprises a synchronization message.

Aspect 23: The method of aspect 14, wherein a quantity of modulation windows associated with communication at the first wireless device corresponds to a quantity of data bits associated with the first wireless device, a bandwidth, a subcarrier spacing, or any combination thereof.

Aspect 24: The method of any of aspects 14 through 23, further comprising: selecting a modulation scheme corresponding to at least the incident signal; and outputting an indication of the modulation scheme in accordance with selecting the modulation scheme and in accordance with applying the modulation scheme for at least the incident signal.

Aspect 25: A first wireless device for wireless communications, comprising one or more memories storing processor-executable code, and one or more processors coupled with the one or more memories and individually or collectively operable to execute the code to cause the first wireless device to perform a method of any of aspects 1 through 13.

Aspect 26: A first wireless device for wireless communications, comprising at least one means for performing a method of any of aspects 1 through 13.

Aspect 27: A non-transitory computer-readable medium storing code for wireless communications, the code comprising instructions executable by one or more processors to perform a method of any of aspects 1 through 13.

Aspect 28: A second wireless device for wireless communications, comprising one or more memories storing processor-executable code, and one or more processors coupled with the one or more memories and individually or collectively operable to execute the code to cause the second wireless device to perform a method of any of aspects 14 through 24.

Aspect 29: A second wireless device for wireless communications, comprising at least one means for performing a method of any of aspects 14 through 24.

Aspect 30: A non-transitory computer-readable medium storing code for wireless communications, the code comprising instructions executable by one or more processors to perform a method of any of aspects 14 through 24.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first wireless device, comprising:
one or more memories storing processor-executable code; and
one or more processors coupled with the one or more memories and individually or collectively operable to execute the code to cause the first wireless device to:
obtain an incident signal;
select a chip rate according to a subcarrier data mapping;
generate a reflected signal in accordance with a periodic load switching pattern applied to the incident signal at a frequency corresponding to the selected chip rate; and
output the reflected signal, wherein a first subset of resource elements of the reflected signal are energy-bearing resource elements that satisfy the subcarrier data mapping, and a second subset of resource elements of the reflected signal are non-energy-bearing resource elements that satisfy the subcarrier data mapping.

2. The first wireless device of claim 1, wherein the incident signal is obtained via one or more initial energy-bearing resource elements, and the one or more processors are individually or collectively further operable to execute the code to cause the first wireless device to:
perform, by applying the periodic load switching pattern, a frequency domain shift to the one or more initial energy-bearing resource elements according to the subcarrier data mapping, wherein one or more shifted energy-bearing resource elements comprise the first subset of resource elements.

3. The first wireless device of claim 2, wherein:
a threshold chip rate corresponds to a threshold shifting offset, and
performing the frequency domain shift is in accordance with the threshold shifting offset.

4. The first wireless device of claim 1, wherein the one or more processors are individually or collectively further operable to execute the code to cause the first wireless device to:
communicate a set of data associated with the first wireless device in accordance with applying the periodic load switching pattern, wherein the set of data is indicated by a frequency domain location of the first subset of resource elements.

5. The first wireless device of claim 1, wherein the one or more processors are individually or collectively further operable to execute the code to cause the first wireless device to:
determine a first modulation window, wherein selecting the chip rate is in accordance with the first modulation window.

6. The first wireless device of claim 5, wherein the energy-bearing resource elements, the non-energy-bearing resource elements, or both are included within at least the first modulation window.

7. The first wireless device of claim 5, wherein:
a width of the first modulation window is in accordance with a bandwidth, a subcarrier spacing, or both corresponding to a communication channel of the first wireless device, and
the width of the first modulation window is further in accordance with the subcarrier data mapping.

8. The first wireless device of claim 1, wherein the one or more processors are individually or collectively further operable to execute the code to cause the first wireless device to:
determine one or more second modulation windows, wherein a quantity of modulation windows including a first modulation window and the one or more second modulation windows corresponds to a quantity of data bits associated with the first wireless device, a bandwidth, a subcarrier spacing, or any combination thereof corresponding to a communication channel of the first wireless device.

9. The first wireless device of claim 8, wherein the one or more processors are individually or collectively further operable to execute the code to cause the first wireless device to:
obtain, within the one or more second modulation windows, one or more repetitions of the incident signal, wherein the one or more repetitions of the incident signal comprise one or more resource elements that are different than one or more resource elements of the incident signal; and
output one or more additional reflected signals within the one or more second modulation windows in accordance with receiving the one or more repetitions of the incident signal and applying the periodic load switching pattern to the one or more repetitions of the incident signal.

10. The first wireless device of claim 9, wherein:
each repetition of the one or more repetitions of the incident signal corresponds to a different modulation window of the one or more second modulation windows.

11. The first wireless device of claim 8, wherein:
a first portion of the energy-bearing resource elements, the non-energy-bearing resource elements, or both are included within a first modulation window, and
a second portion of the energy-bearing resource elements, the non-energy-bearing resource elements, or both are included within the one or more second modulation windows.

12. The first wireless device of claim 1, wherein the one or more processors are individually or collectively further operable to execute the code to cause the first wireless device to:
receive an indication of a threshold shifting offset in accordance with a power leakage value, wherein selecting the chip rate is in accordance with the threshold shifting offset.

13. The first wireless device of claim 1, wherein the one or more processors are individually or collectively further operable to execute the code to cause the first wireless device to:
generate a set of data, wherein selecting the chip rate is in accordance with the set of data.

14. A second wireless device, comprising:
one or more memories storing processor-executable code; and
one or more processors coupled with the one or more memories and individually or collectively operable to execute the code to cause the second wireless device to:
output, via a first wireless device to a third wireless device, an incident signal comprising one or more initial energy-bearing resource elements; and
output, to at least one of the first wireless device or the third wireless device, an indication of a subcarrier data mapping, the subcarrier data mapping corresponding to a set of data associated with the first wireless device.

15. The second wireless device of claim 14, wherein the incident signal is output during a first modulation window, and the one or more processors are individually or collectively further operable to execute the code to cause the second wireless device to:
output, within one or more second modulation windows that are non-overlapping with the first modulation window, one or more repetitions of the incident signal.

16. The second wireless device of claim 15, wherein a quantity of the one or more second modulation windows is determined in accordance with a threshold demodulation accuracy.

17. The second wireless device of claim 14, wherein the one or more processors are individually or collectively further operable to execute the code to cause the second wireless device to:
output an indication of a threshold shifting offset in accordance with a power leakage value.

18. The second wireless device of claim 17, wherein the one or more processors are individually or collectively further operable to execute the code to cause the second wireless device to:
output an indication that the subcarrier data mapping includes an initial energy-bearing resource element associated with the incident signal, one or more shifted energy-bearing resource elements comprising one or more frequency domain shifts of the initial energy-bearing resource element, or any combination thereof in accordance with the threshold shifting offset.

19. The second wireless device of claim 14, wherein the incident signal is output during a first modulation window, and the one or more processors are individually or collectively further operable to execute the code to cause the second wireless device to:
communicate, within one or more second modulation windows that are non-overlapping with the first modulation window, additional signaling with one or more additional devices.

20. The second wireless device of claim 19, wherein:
the one or more additional devices comprise user equipments (UEs).

21. The second wireless device of claim 14, wherein the one or more processors are individually or collectively further operable to execute the code to cause the second wireless device to:
output an indication of a quantity of bits associated with the first wireless device.

22. The second wireless device of claim 21, wherein the indication of the quantity of bits comprises a synchronization message.

23. The second wireless device of claim 14, wherein a quantity of modulation windows associated with communication at the first wireless device corresponds to a quantity of data bits associated with the first wireless device, a bandwidth, a subcarrier spacing, or any combination thereof.

24. The second wireless device of claim 14, wherein the one or more processors are individually or collectively further operable to execute the code to cause the second wireless device to:
select a modulation scheme corresponding to at least the incident signal; and
output an indication of the modulation scheme in accordance with selecting the modulation scheme and in accordance with applying the modulation scheme for at least the incident signal.

25. A method for wireless communications by a first wireless device, comprising:
obtaining an incident signal;
selecting a chip rate according to a subcarrier data mapping;
generating a reflected signal in accordance with a periodic load switching pattern applied to the incident signal at a frequency corresponding to the selected chip rate; and
outputting the reflected signal, wherein a first subset of resource elements of the reflected signal are energy-bearing resource elements that satisfy the subcarrier data mapping, and a second subset of resource elements of the reflected signal are non-energy-bearing resource elements that satisfy the subcarrier data mapping.

26. The method of claim 25, wherein the incident signal is obtained via one or more initial energy-bearing resource elements, the method further comprising:
performing, by applying the periodic load switching pattern, a frequency domain shift to the one or more initial energy-bearing resource elements according to the subcarrier data mapping, wherein one or more shifted energy-bearing resource elements comprise the first subset of resource elements.

27. The method of claim 26, wherein a threshold chip rate corresponds to a threshold shifting offset, and wherein performing the frequency domain shift is in accordance with the threshold shifting offset.

28. The method of claim 25, further comprising:
communicating a set of data associated with the first wireless device in accordance with applying the periodic load switching pattern, wherein the set of data is indicated by a frequency domain location of the first subset of resource elements.

29. The method of claim 25, further comprising:
determining a first modulation window, wherein selecting the chip rate is in accordance with the first modulation window.

30. The method of claim 29, wherein the energy-bearing resource elements, the non-energy-bearing resource elements, or both are included within at least the first modulation window.
